(19) United States
(12) Patent Application Publication
(10) Pub. No.: US 2022/0225189 A1
(43) Pub. Date: Jul. 14, 2022

(54) METHOD AND APPARATUS FOR SLICE SPECIFIC CELL SELECTION PROCEDURE IN WIRELESS COMMUNICATION SYSTEM

(71) Applicant: Samsung Electronics Co., Ltd., Suwon-si (KR)

(72) Inventors: Hyunjeong KANG, Suwon-si (KR); Anil AGIWAL, Suwon-si (KR); Soenghun KIM, Suwon-si (KR); Sangyeob JUNG, Suwon-si (KR)

(21) Appl. No.: 17/648,068

(22) Filed: Jan. 14, 2022

(30) Foreign Application Priority Data
Jan. 14, 2021 (KR) 10-2021-0005567
Nov. 1, 2021 (KR) 10-2021-0148257

(51) Int. Cl. H04W 36/00; H04W 48/20

(52) U.S. Cl. CPC H04W 36/00835; H04W 48/20; H04W 36/0072

(57) ABSTRACT

The disclosure relates to a communication method and system for converging a 5th-Generation (5G) communication system for supporting higher data rates beyond a 4th-Generation (4G) system with a technology for Internet of Things (IoT). The disclosure may be applied to intelligent services based on the 5G communication technology and the IoT-related technology, such as smart home, smart building, smart city, smart car, connected car, health care, digital education, smart retail, security and safety services. The disclosure provides a method performed by a terminal, comprising: receiving, from a base station, slice information for a cell reselection; identifying a slice among one or more slices based on slice priority information; identifying a cell that is a strongest and suitable cell based on the slice information; and in case that the cell supports the slice, selecting the cell.

### CROSS-REFERENCE TO RELATED APPLICATIONS

This application is based on and claims priority under 35 U.S.C. § 119 to Korean Patent Application No. 10-2021-0005567, filed on Jan. 14, 2021, in the Korean Intellectual Property Office and Korean Patent Application No. 10-2021-0148257, filed on Nov. 1, 2021, in the Korean Intellectual Property Office, the disclosure of which is herein incorporated by reference in its entirety.

### BACKGROUND

### 1) Field

The disclosure relates to a wireless communication system and, more particularly, to a method and apparatus for performing a slice-based cell selection and cell reselection procedure by a terminal in a wireless communication system.

### 2) Description of Related Art

To meet the demand for wireless data traffic having increased since deployment of 4th-Generation (4G) communication systems, efforts have been made to develop an improved 5th-Generation (5G) or pre-5G communication system. Therefore, the 5G or pre-5G communication system is also called a ‘Beyond 4G Network’ or a ‘Post Long-Term Evolution (LTE) System.’ The 5G communication system is considered to be implemented in higher frequency (millimeter (mm) Wave) bands, e.g., 60 gigahertz (GHz) bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid frequency shift keying (FSK) and quadrature amplitude modulation (QAM) Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology,” “wired/wireless communication and network infrastructure,” “service interface technology,” and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In 5G, network slicing technology has been introduced. Each network slice refers to an isolated end-to-end network tailored to fulfill diverse requirements requested by a particular application.

The above information is presented as background information only to assist with an understanding of the disclosure. No determination has been made, and no assertion is made, as to whether any of the above might be applicable as prior art with regard to the disclosure.

### SUMMARY

An aspect of the disclosure is to provide an apparatus and a method for performing a cell selection procedure based on slice information in a wireless communication system.

Further, according to an embodiment of the disclosure, an apparatus and a method for performing a cell reselection procedure based on slice information in a communication system are provided.

In addition, according to an embodiment of the disclosure, an apparatus and a method for obtaining slice information from information for a cell selection procedure and information for a cell reselection procedure in a wireless communication system are provided.

According to an embodiment of the disclosure, a method for performing a cell selection procedure based on slice information in a wireless communication system may include: determining slice information supportable by a cell from cell selection procedure information acquired from a base station; and performing a procedure for cell selection. The method for performing a cell selection procedure may include selecting a cell by applying at least one of slice information and signal strength information included in cell selection procedure information or a combination thereof.

According to an embodiment of the disclosure, a method for performing a cell reselection procedure based on slice information in a wireless communication system may include: determining slice information supportable by a cell from cell reselection procedure information acquired from a base station; and performing a procedure for cell selection. The method for performing a cell reselection procedure may include selecting a cell by applying at least one of slice information and signal strength information included in cell reselection procedure information or a combination thereof.

According to an embodiment of the disclosure, a method performed by a terminal in a communication system is provided. The method including: receiving, from a base station, slice information for a cell reselection; identifying a slice among one or more slices based on slice priority information; identifying a cell that is a strongest and suitable cell based on the slice information; and in case that the cell supports the slice, selecting the cell.

According to an embodiment of the disclosure, a terminal in a communication system is provided. The terminal comprises: a transceiver; and a controller coupled with the transceiver and configured to: receive, from a base station, slice information for a cell reselection, identify a slice among one or more slices based on slice priority information, identify a cell that is a strongest and suitable cell based on the slice information, and in case that the cell supports the slice, select the cell.

According to an embodiment of the disclosure, a method performed by a base station in a communication system is provided. The method including: transmitting, to a base station, slice information for a cell reselection, wherein a slice among one or more slices is identified based on slice priority information, a cell that is a strongest and suitable cell is identified based on the slice information, and in case that the cell supports the slice, the cell is selected.

According to an embodiment of the disclosure, a base station in a communication system is provided. The base station comprises: a transceiver; and a controller coupled with the transceiver and configured to: transmit, to a base station, slice information for a cell reselection, wherein a slice among one or more slices is identified based on slice priority information, a cell that is a strongest and suitable cell is identified based on the slice information, and in case that the cell supports the slice, the cell is selected.

According to the disclosure, when a terminal performs cell selection and cell reselection, the terminal may determine, based on network slice information, whether a requested service can be supported through the corresponding cell. That is, based on the network slice information, it is possible to determine whether cell selection and cell reselection can be performed, and thus a service required by the terminal can be provided without delay or a system access procedure performed until the terminal is provided with a required service can be efficiently processed.

Effects that could be obtained based on the disclosure are not limited to the above-described effects, and those skilled in the art would clearly understand, based on the descriptions provided below, other effects which are not mentioned above.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the disclosure and its advantages, reference is now made to the following description taken in conjunction with the accompanying drawings, in which like reference numerals represent like parts:

The above and other objectives, features, and advantages of the disclosure will become clearer through the following description of embodiments of the disclosure with reference to the accompanying drawings.

FIG. 1 illustrates a wireless communication system according to an embodiment of the disclosure;

FIG. 2 illustrates a configuration of a base station in a wireless communication system according to an embodiment of the disclosure;

FIG. 3 illustrates a configuration of a terminal in a wireless communication system according to an embodiment of the disclosure;

FIG. 4 illustrates a configuration of a communication unit in a wireless communication system according to an embodiment of the disclosure;

FIG. 5 illustrates the structure of radio time-frequency resources of a wireless communication system according to an embodiment of the disclosure;

FIG. 6A illustrates an operation of a terminal for determining an option of a cell selection procedure or a cell reselection procedure according to an embodiment of the disclosure;

FIG. 6B illustrates a slice-based cell selection operation of a terminal according to an embodiment of the disclosure;

FIG. 7 illustrates an operation in which a terminal performs a cell selection procedure according to various embodiments of the disclosure;

FIG. 8 illustrates an operation in which a terminal performs a cell selection procedure according to various embodiments of the disclosure;

FIG. 9 illustrates an operation in which a terminal performs a cell selection procedure according to various embodiments of the disclosure;

FIG. 10 illustrates an operation in which a terminal performs a cell selection procedure according to various embodiments of the disclosure; and

FIG. 11 illustrates an operation in which a terminal performs a cell selection procedure according to various embodiments of the disclosure.

### DETAILED DESCRIPTION

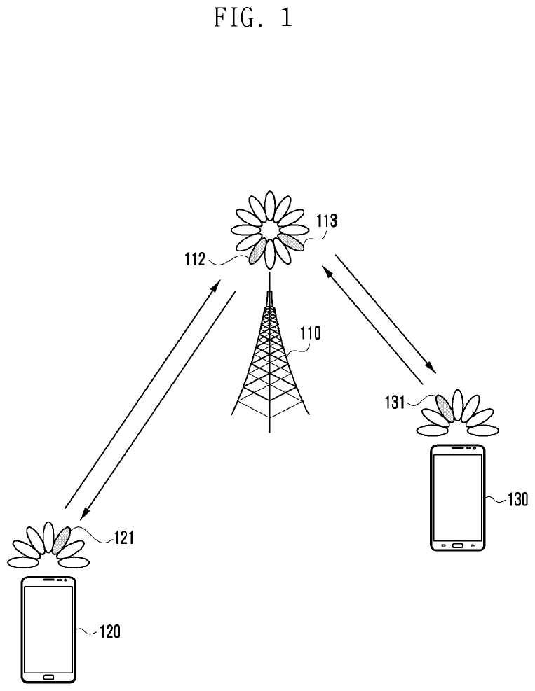

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, exemplary embodiments of the disclosure will be described in detail with reference to the accompanying drawings. It should be noted that, in the drawings, the same or like elements are designated by the same or like reference signs as much as possible. Further, a detailed description of known functions or configurations that may make the subject matter of the disclosure unclear will be omitted.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card.

The following detailed description of embodiments of the disclosure is mainly directed to new RAN (NR) as a radio access network and packet core as a core network (5G system, 5G core network, or new generation core (NG Core)) which are specified in the 5G mobile communication standards defined by the 3GPP that is a mobile communication standardization group, but based on determinations by those skilled in the art, the main idea of the disclosure may be applied to other communication systems having similar backgrounds through some modifications without significantly departing from the scope of the disclosure.

The 5G system may define a network data collection and analysis function (NWDAF) that provides a function of analyzing data collected by 5G network and providing the collected data to support network automation. The NWDAF may collect, store, and analyze information from the 5G network to provide the result thereof to an unspecific network function (NF), and the analysis result may be independently used by each NE

Hereinafter, terms and names defined by the third generation partnership project (3GPP) long term evolution standards (5G, NR, LTE, or standards of the similar systems) may be partially used for convenience of description. However, the disclosure may not be limited by the terms and names, and may be equally applied to a system that is based on another standard.

Hereinafter, the disclosure relates to an apparatus and a method in which a terminal performs a cell selection procedure and a cell reselection procedure based on cell selection information including slice information acquired from a base station and cell reselection information including the slice information in a wireless communication system. Specifically, the disclosure relates to an apparatus and a method in which a terminal performs a cell selection procedure of selecting a cell based on at least one slice information and signal strength information included in cell selection information acquired from a base station or a combination thereof, and performs a cell reselection procedure based on at least one of slice information and signal strength information included in cell reselection information acquired from the base station or a combination thereof.

In the following description, terms referring to a signal, terms referring to a channel, terms referring to control information, terms referring to network entities, and terms referring to elements of a device are exemplified for convenience of description. Accordingly, the terms used in the disclosure are not limited, and other terms referring to objects having the equivalent technical meanings may be used.

In the following description, “physical channel” and “signal” may be used interchangeably with “data” or “control signal.” For example, “physical downlink shared channel (PDSCH)” is a term that refers to a physical channel through which data is transmitted, but “PDSCH” may also be used to refer to data. That is, in the disclosure, the expression “to transmit a physical channel” may be interpreted equivalently to the expression “to transmit data or signals through a physical channel.”

Hereinafter, in the disclosure, “higher-layer signaling” refers to a signal transmission method for transmission from a base station to a terminal using a downlink data channel of a physical layer or transmission from a terminal to a base station using an uplink data channel of the physical layer. Higher-layer signaling may be understood as radio resource control (RRC) signaling or media access control (MAC) control element (CE) signaling.

In addition, in the disclosure, in order to determine whether a specific condition is satisfied or fulfilled, the expression “greater than” or “less than” may be used, but this is only a description for expressing an example, and does not exclude the cases of “equal to or more than” or “equal to or less than.” Conditions described as “equal to or more than” may be replaced with “greater than,” conditions described as “equal to or less than” may be replaced with “less than,” and conditions described as “equal to or more than, and less than” may be replaced with “greater than, and equal to or less than.”

In addition, the disclosure describes embodiments using terms used in some communication standards (e.g., the 3rd generation partnership project (3GPP)), but this is only an example for description. Embodiments of the disclosure may be easily modified and applied to other communication systems.

FIG. 1 illustrates a wireless communication system according to an embodiment of the disclosure.

FIG. 1 illustrates a base station 110, a terminal 120, and a terminal 130, as a part of nodes which use a wireless channel in a wireless communication system. FIG. 1 illustrates only one base station, but other base stations identical or similar to the base station 110 may be further included.

The base station 110 is a network infrastructure for providing wireless access to the terminals 120 and 130. The base station 110 includes a coverage which is defined as a predetermined geographic area based on a distance in which signal transmission is possible. The base station 110 may be referred to as, in addition to a base station, an “access point (AP),” an “eNodeB (eNB),” a “fifth generation node (5G node),” a “next generation node B (gNB),” a “wireless point,” a “transmission/reception point (TRP)” or other terms having an equivalent technical meaning thereof.

Each of the terminal 120 and the terminal 130 is a device used by a user, and performs communication with the base station 110 through a wireless channel. A link from the base station 110 to the terminal 120 or the terminal 130 is referred to as a downlink (DL), and a link from the terminal 120 or the terminal 130 to the base station 110 is referred to as an uplink (UL). In some cases, at least one of the terminal 120 and the terminal 130 may be operated without user involvement. That is, at least one of the terminal 120 and the terminal 130 is a device for performing machine type communication (MTC), and may not be carried by a user. Each of the terminal 120 and the terminal 130 may be referred to as, in addition to a terminal, a “user equipment (UE),” a “mobile station,” a “subscriber station,” or a “remote terminal,” a “wireless terminal,” a “user device,” or other terms having an equivalent technical meaning thereof.

The base station 110, the terminal 120, and the terminal 130 may transmit or receive a radio signal in a mmWave band (e.g., 28 GHz, 30 GHz, 38 GHz, and 60 GHz). Here, in order to improve a channel gain, the base station 110, the terminal 120, and the terminal 130 may perform beamforming. Here, beamforming may include transmission beamforming and reception beamforming. That is, the base station 110, the terminal 120, and the terminal 130 may give directivity to a transmission signal or a reception signal. To this end, the base station 110 and the terminals 120 and 130 may select serving beams 112, 113, 121, and 131 through a beam search or beam management procedure. After the serving beams 112, 113, 121, and 131 are selected, the subsequent communication is performed through a resource which is in a quasi-co-located (QCL) relationship with a resource having transmitted the serving beams 112, 113, 121, and 131.

A first antenna port and a second antenna port may be said to be in a QCL relationship if the large-scale characteristics of the channel over which a symbol on the first antenna port is transferred can be inferred from the channel over which a symbol on the second antenna port is transferred. For example, the large-scale characteristics of the channel may include at least one of delay spread, Doppler spread, Doppler shift, average gain, and average delay, and spatial receiver parameter.

Abase station and a terminal are connected through a Uu interface. Uplink (UL) refers to a radio link through which the terminal transmits data or control signals to the base station, and downlink (DL) refers to a radio link through which the base station transmits data or control signals to the terminal.

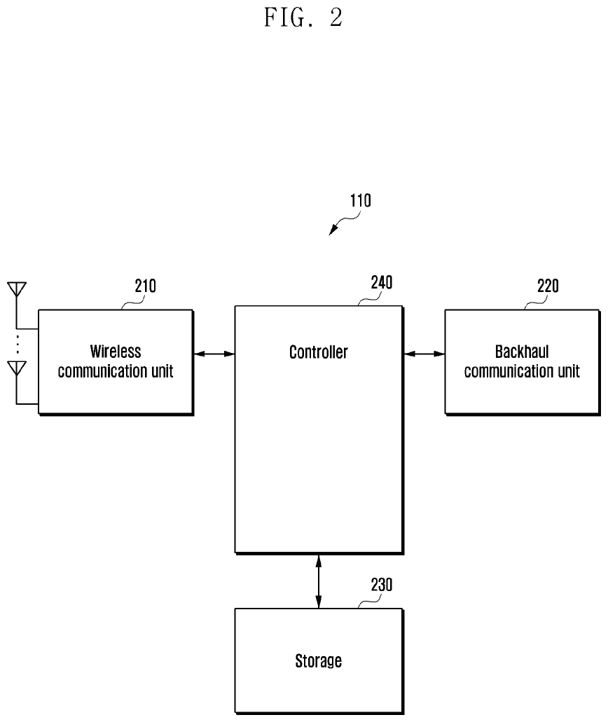

FIG. 2 illustrates a configuration of a base station in a wireless communication system according to an embodiment of the disclosure.

The configuration illustrated in FIG. 2 may be understood as a configuration of the base station 110. The term “unit” or terms ending with suffixes “-er” and “-or” used in the following description refer to a unit which processes at least one function or operation, and may be implemented by hardware, software, or a combination of hardware and software.

Referring to FIG. 2, the base station 110 includes a wireless communication unit 210, a backhaul communication unit 220, a storage 230, and a controller 240. However, the elements of the base station are not limited to the above-described example. For example, the base station may include more or fewer elements than the above-described elements. Further, the wireless communication unit 210, the backhaul communication unit 220, the storage 230, and the controller 240 may be implemented in the form of a single chip. In addition, the controller 240 may include one or more processors.

The wireless communication unit 210 performs functions for transmitting or receiving signals through a wireless channel. For example, the wireless communication unit 210 performs a conversion function between a baseband signal and a bit string according to a physical layer standard of a system. For example, at the time of data transmission, the wireless communication unit 210 generates complex symbols by encoding and modulating a transmission bit string. In addition, at the time of data reception, the wireless communication unit 210 reconstructs a reception bit string by demodulating and decoding the baseband signal.

In addition, the wireless communication unit 210 up-converts a baseband signal into a radio frequency (RF) band signal and transmits the signal through an antenna, and down-converts an RF band signal received through the antenna into a baseband signal. To this end, the wireless communication unit 210 may include a transmission filter, a reception filter, an amplifier, a mixer, an oscillator, a digital to analog convertor (DAC), an analog to digital converter (ADC), and the like. Further, the wireless communication unit 210 may include a plurality of transmission/reception paths. Furthermore, the wireless communication unit 210 may include at least one antenna array configured by a plurality of antenna elements.

In the hardware aspect, the wireless communication unit 210 may include a digital unit and an analog unit, and the analog unit may include a plurality of sub-units according to operating power, operating frequency, and the like. The digital unit may be implemented by at least one processor (e.g., a digital signal processor (DSP)).

The wireless communication unit 210 transmits or receives signals as described above. Accordingly, all or part of the wireless communication unit 210 may be referred to as a “transmitter,” a “receiver,” a “transmitter/receiver,” or a “transceiver.” In addition, in the following description, transmission or reception performed through a wireless channel may include performing processing by the wireless communication unit 210 as described above.

The backhaul communication unit 220 provides an interface for performing communication with other nodes in a network. That is, the backhaul communication unit 220 converts a bit string, which is transmitted from the base station 110 to another node, for example, another access node, another base station, an upper node, and a core network, into a physical signal, and converts a physical signal, which is received from another node, into a bit string.

The storage 230 stores data, such as a basic program, an application program, and configuration information for the operation of the base station 110. The storage 230 may include a volatile memory, a nonvolatile memory, or a combination of a volatile memory and a nonvolatile memory. Then, the storage 230 provides the stored data at the request of the controller 240.

The controller 240 controls overall operations of the base station 110. For example, the controller 240 transmits or receives signals through the wireless communication unit 210 or the backhaul communication unit 220. In addition, the controller 240 records or reads data in or from the storage 230. In addition, the controller 240 may perform functions of a protocol stack required in the communication standard. According to another example of implementation, the protocol stack may be included in the wireless communication unit 210. To this end, the controller 240 may include at least one processor. According to embodiments, the controller 240 may control the base station 110 to perform operations according to embodiments to be described later.

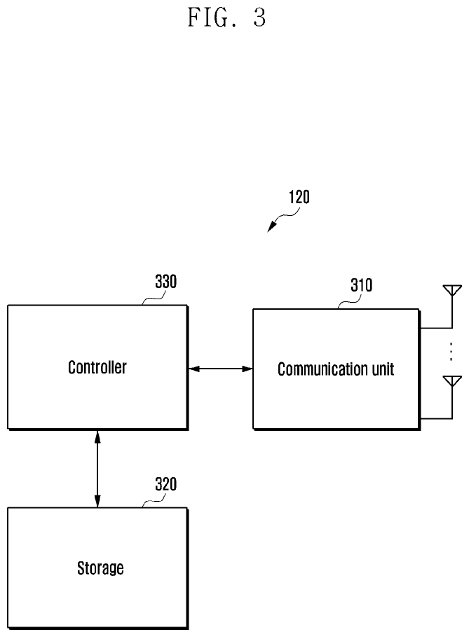

FIG. 3 illustrates the configuration of a terminal in a wireless communication system according to an embodiment of the disclosure.

The configuration illustrated in FIG. 3 may be understood as the configuration of the terminal 120. The term “unit” or terms ending with suffixes “-er” and “-or” used hereinafter refer to a unit which processes at least one function or operation, and may be implemented by hardware, software, or a combination of hardware and software.

Referring to FIG. 3, the terminal 120 includes a communication unit 310, a storage 320, and a controller 330. However, the elements of the terminal 120 are not limited to the above-described example. For example, the terminal 120 may include more or fewer elements than the above-described elements. Further, the communication unit 310, the storage 320, and the controller 330 may be implemented in the form of a single chip. In addition, the controller 330 may include one or more processors.

The communication unit 310 performs functions for transmitting or receiving signals through a wireless channel. For example, the communication unit 310 performs a conversion function between a baseband signal and a bit string according to a physical layer standard of the system. For example, at the time of data transmission, the communication unit 310 generates complex symbols by encoding and modulating a transmission bit string. In addition, at the time of data reception, the communication unit 310 reconstructs the received bit string by demodulating and decoding the baseband signal. In addition, the communication unit 310 up-converts a baseband signal into an RF band signal and transmits the signal through an antenna, and down-converts an RF band signal received through the antenna into a baseband signal. For example, the communication unit 310 may include a transmission filter, a reception filter, an amplifier, a mixer, an oscillator, a DAC, and an ADC.

Further, the communication unit 310 may include a plurality of transmission/reception paths. Furthermore, the communication unit 310 may include at least one antenna array including a plurality of antenna elements. In the hardware aspect, the communication unit 310 may include a digital circuit and an analog circuit (e.g., a radio frequency integrated circuit (RFIC)). Here, the digital circuit and the analog circuit may be implemented in one package. In addition, the communication unit 310 may include a plurality of RF chains. Furthermore, the communication unit 310 may perform beamforming.

The communication unit 310 transmits or receives signals as described above. Accordingly, all or a part of the communication unit 310 may be referred to as a “transmitter,” a “receiver,” or a “transceiver.” In addition, in the following description, transmission and reception performed through a wireless channel may include performing processing which is performed by the communication unit 310 as described above.

The storage 320 stores data, such as a basic program, an application program, and configuration information for the operation of the terminal 120. The storage 320 may include a volatile memory, a nonvolatile memory, or a combination of a volatile memory and a nonvolatile memory. Then, the storage 320 provides the stored data at the request of the controller 330.

The controller 330 controls overall operations of the terminal 120. For example, the controller 330 transmits or receives signals through the communication unit 310. In addition, the controller 330 records or reads data in or from the storage 320. In addition, the controller 330 may perform functions of a protocol stack required by the communication standard. To this end, the controller 330 may include at least one processor or microprocessor, or may be a part of the processor. In addition, a part of the communication unit 310 and the controller 330 may be referred to as a communication processor (CP). According to embodiments, the controller 330 may control the terminal 120 to perform operations according to embodiments to be described later.

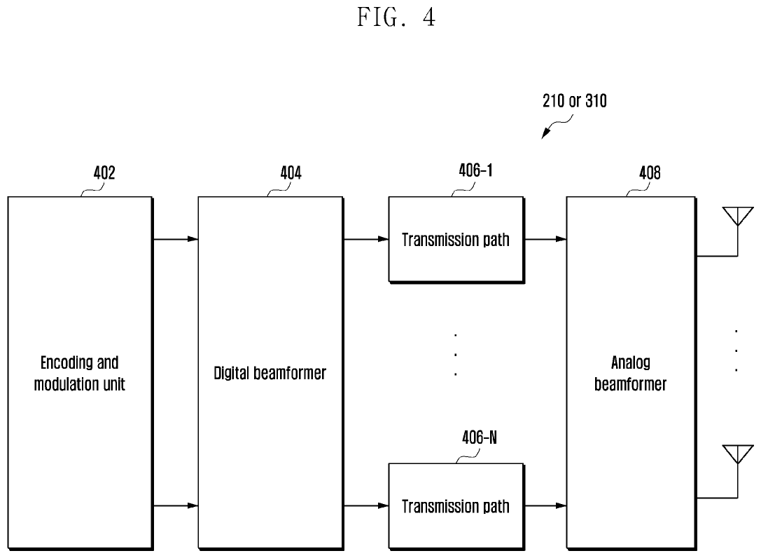

FIG. 4 illustrates a configuration of a communication unit in a wireless communication system according to an embodiment of the disclosure.

FIG. 4 illustrates an example of a detailed configuration of the wireless communication unit 210 of FIG. 2 or the communication unit 310 of FIG. 3. Specifically, FIG. 4 illustrates elements for performing beamforming, as a part of the wireless communication unit 210 of FIG. 2 or as a part of the communication unit 310 of FIG. 3.

Referring to FIG. 4, the wireless communication unit 210 or the communication unit 310 includes an encoding and modulation unit 402, a digital beamformer 404, a plurality of transmission paths 406-1 to 406-N, and an analog beamformer 408.

The encoding and modulation unit 402 performs channel encoding. In order to perform channel encoding, at least one of a low density parity check (LDPC) code, a convolution code, and a polar code may be used. The encoding and modulation unit 402 generates modulation symbols by performing constellation mapping.

The digital beamformer 404 performs beamforming of a digital signal (e.g., modulation symbols). To this end, the digital beamformer 404 multiplies the modulation symbols by beamforming weights. Here, the beamforming weights are used to change the magnitude and the phase of the signal, and may be referred to as a “precoding matrix.” a “precoder,” or the like. The digital beamformer 404 outputs the digital-beamformed modulation symbols via the plurality of transmission paths 406-1 to 406-N. Here, according to a multiple-input multiple-output (MIMO) transmission scheme, the modulation symbols may be multiplexed, or the same modulation symbols may be provided via the plurality of transmission paths 406-1 to 406-N.

The plurality of transmission paths 406-1 to 406-N convert the digital-beamformed digital signals into analog signals. To this end, each of the plurality of transmission paths 406-1 to 406-N may include an inverse fast Fourier transform (IFFT) operation unit, a cyclic prefix (CP) inserter, a DAC, and an up-converter. The CP inserter is for an orthogonal frequency division multiplexing (OFDM) scheme, and may be excluded when another physical layer scheme (e.g., filter bank multi-carrier (FBMC)) is applied. That is, the plurality of transmission paths 406-1 to 406-N provide independent signal processing processes to a plurality of streams generated through digital beamforming. However, some of elements of the plurality of transmission paths 406-1 to 406-N may be used in common according to the implementation scheme.

The analog beamformer 408 performs beamforming of analog signals. To this end, the digital beamformer 404 multiplies the analog signals by beamforming weights. Here, the beamforming weights are used to change the magnitude and the phase of a signal. Specifically, the analog beamformer 440 may be variously configured according to a connection structure between the plurality of transmission paths 406-1 to 406-N and antennas. For example, each of the plurality of transmission paths 406-1 to 406-N may be connected to one antenna array. As another example, the plurality of transmission paths 406-1 to 406-N may be connected to one antenna array. As another example, the plurality of transmission paths 406-1 to 406-N may be adaptively connected to one antenna array, or may be connected to two or more antenna arrays.

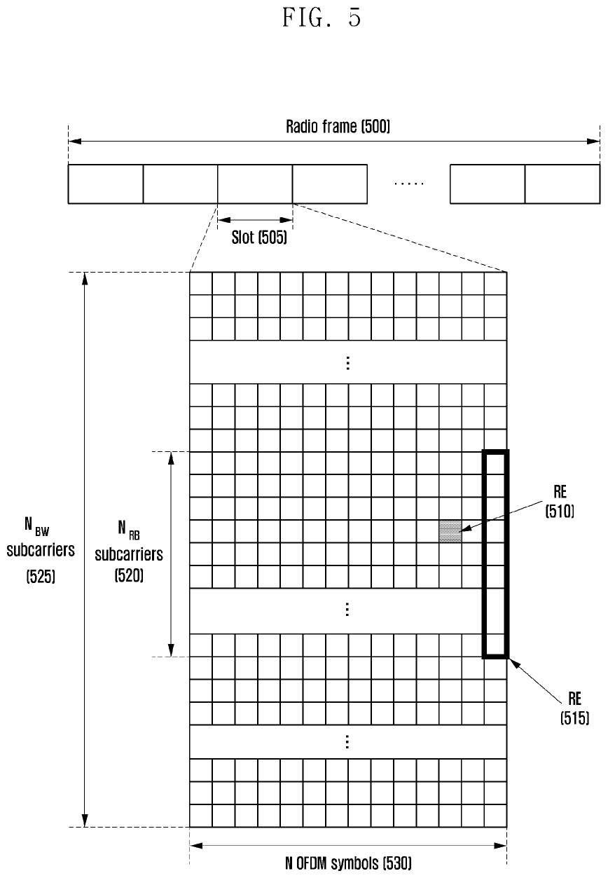

FIG. 5 illustrates the structure of radio time-frequency resources of a wireless communication system according to an embodiment of the disclosure.

Referring to FIG. 5, in the radio resource domain, the horizontal axis represents a time domain and the vertical axis represents a frequency domain. The minimum transmission unit in the time domain is an OFDM symbol or a DFT-S-OFDM symbol, and Nsymb OFDM symbols or DFT-S-OFDM symbols 530 are one included in slot 505. Unlike the slot, the length of the subframe in the NR system may be defined as 1.0 ms, and the length of the radio frame 500 may be defined as 10 ms. The minimum transmission unit in the frequency domain is a subcarrier, and the bandwidth of the entire system transmission band may include a total of NBW subcarriers 525. Specific values such as Nsymb and NBW may be variably applied depending on the system.

The basic unit of the time-frequency resource domain is a resource element (RE) 510, which may be indicated by an OFDM symbol index, a DFT-S-OFDM symbol index, and a subcarrier index. A resource block (RB) 515 may be defined by consecutive NRB subcarriers 520 in the frequency domain. In general, the minimum transmission unit of data is an RB unit, and generally, Nsymb=14 and NRB=12 in the NR system.

The structure of the radio time-frequency resources as shown in FIG. 5 may be applied to a Uu interface.

Meanwhile, one network may provide one or multiple vertical slices and services. Table 1 shows examples of slice/service type (SST) values of vertical slices/services and corresponding slices/services.

TABLE 1

| Slice/Service type (SST) | SST value | Characteristics |
|---|---|---|
| eMBB | 1 | Slice suitable for the handling |
| | | of 5G enhanced Mobile |
| | | Broadband. |
| URLLC | 2 | Slice suitable for the handling |
| | | of ultra-reliable low latency |
| | | communications. |
| mIoT | 3 | Slice suitable for the handling |
| | | of massive IoT. |
| V2X | 4 | Slice suitable for the handling |
| | | of V2X services. |

A terminal may be configured with one or more pieces of slice information. This slice information may be configured as configured slices in the terminal. When there is a need to receive a service, the terminal may select a slice corresponding to the service from the configured slices. Here, the slice may correspond to a slice intended by the terminal. The slice intended by the terminal may correspond to one slice occurring during cell selection or cell reselection. The configured slice configured in the terminal may include a default slice and a preferred slice. That is, a network entity configured to control the slice of the terminal may configure, in the terminal, a slice corresponding to the default slice among the configured slices of the terminal and a slice corresponding to the preferred slice among the configured slices.

When it is determined that the frequency or cell does not support the intended slice required when the terminal performs a cell selection procedure or performs a cell reselection procedure, if the default slice or the preferred slice among the configured slices of the terminal itself is configured and it is configured to select or reselect a cell supporting a slice corresponding to the default slice or preferred slice, the terminal may select or reselect the cell supporting the slice corresponding to the default slice or preferred slice. When the terminal selects or reselects the cell supporting a slice corresponding to the default slice or preferred slice instead of the intended slice, the terminal may report, to a network entity or a base station, at least one of the intended slice information and the slice (default slice or preferred slice) selected at the time of cell selection/reselection or a combination thereof. If the terminal cannot find a frequency or a cell supporting a slice among the intended slice, the default slice, and the preferred slice, the terminal may perform a connection establishment procedure through a general cell selection or cell reselection procedure.

Here, the terminal may report at least one of the intended slice information, the default slice, and the preferred slice, or a combination thereof to a network entity or a base station. Through information reported by the terminal, the network or the base station may acquire at least one of information on a slice intended by the terminal, default slice or preferred slice information of the terminal, slice information selected when the terminal performs cell selection or cell reselection, and information relating to whether the selected slice is a default slice or a preferred slice, or a combination thereof. Based on the information reported by the terminal, the network entity or the base station may perform redirection to a cell or frequency supporting at least one of a slice intended by the terminal, a default slice, and a preferred slice, may provide a carrier aggregation (CA) or dual connectivity (DC) thereto, or may perform handover thereto.

Here, the network entity or the base station may transfer at least one of the intended slice, the default slice or preferred slice information of the terminal, the slice information selected when the terminal performs cell selection or cell reselection, and information relating to whether the selected slice is the default slice or the preferred slice, which are reported by the terminal, or a combination thereof through an inter-node message, to a base station/network entity of a target cell to which the terminal performs redirection, a target cell to which the terminal performs CA, a target cell to which the terminal performs DC, or a target cell to which the terminal performs handover.

The operation of the terminal reporting the intended slice, default slice, and preferred slice to the base station/network may be performed when satisfying both cases of (A) in which the terminal performs a cell selection operation or cell reselection operation by using at least one of the intended slice, default slice, and preferred slice, and (B) in which the terminal acquires a system information block message including slice-based cell selection information and/or a system information block message including slice-based cell reselection information from the base station. The operation of the terminal reporting the intended slice, default slice, and preferred slice to the base station/network may be performed in a case in which the terminal is configured to perform a cell selection operation or cell reselection operation using at least one of the intended slice, default slice, and preferred slice.

The operation of the terminal reporting the intended slice, default slice, and preferred slice to the base station/network may be performed in a case in which the terminal acquires, from the base station, a system information block message including slice-based cell selection information and/or a system information block message including slice-based cell reselection information. In a case of a terminal or a base station that does not support the slice-based cell selection operation or the slice-based cell reselection operation, the terminal does not support the operation of reporting the intended slice, the default slice, or the preferred slice to the base station/network. That is, in a case of a terminal or a base station that does not support a slice-based cell selection operation or a slice-based cell reselection operation, the terminal may perform an operation of reporting configured slice information to the base station/network as the conventional case. Here, based on the configured slice information report of the terminal, the base station/network may transfer the configured slice information of the terminal through an inter-node message, to a base station/network entity of a target cell to which the terminal performs redirection, a target cell to which the terminal performs CA, a target cell to which the terminal performs DC, or a target cell to which the terminal performs handover.

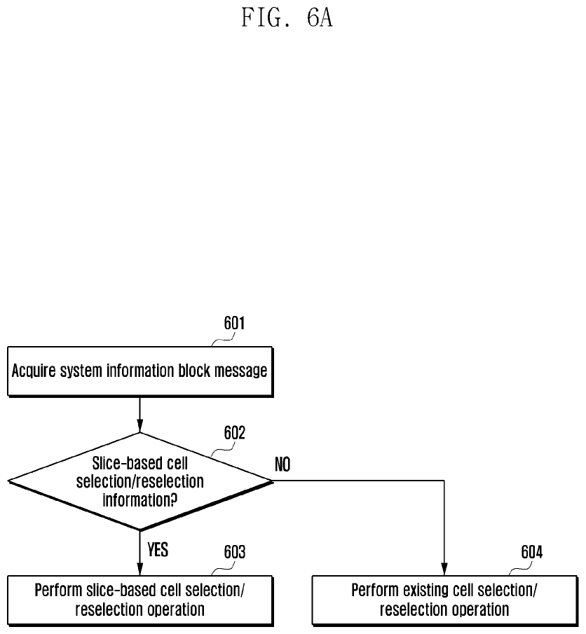

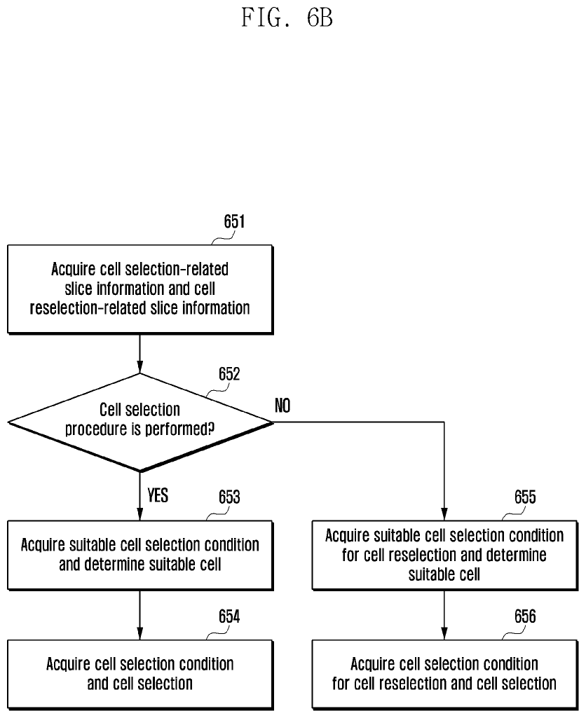

Hereinafter, with reference to FIG. 6A, an operation in which a terminal determines whether slice-based cell selection information and/or slice-based cell reselection information is provided via a system information block message (or, it may be referred to by terms having the same or similar meaning, such as system information and system information block (SIB)) acquired from a base station, and then determines whether to perform a slice-based cell selection procedure/cell reselection procedure or perform a conventional cell selection procedure/cell reselection procedure will be described. Meanwhile, the embodiment of FIG. 6A may be applied even to a case in which the terminal is configured to perform a cell selection operation or a cell reselection operation using at least one of an intended slice, a default slice, and a preferred slice. In the disclosure, a slice intended by the terminal includes at least one of an allowed slice or a configured slice, or a combination thereof.

FIG. 6A illustrates an operation of a terminal for determining an option of a cell selection procedure or a cell reselection procedure according to an embodiment of the disclosure.

Referring to FIG. 6A, the terminal may acquire a system information block message (or a system information block (SIB)) in operation 601. In operation 602, the terminal may determine whether slice-based cell selection information and/or slice-based cell reselection information is provided from (or included in) the obtained system information block message. According to the determination performed in operation 602, if it is determined that slice-based cell selection information and/or slice-based cell reselection information is provided, the terminal may perform a slice-based cell selection or slice-based cell reselection procedure in operation 603. In operation 603, the terminal may perform the same procedure as that of the embodiment of FIGS. 6B to 11, which will be described later, and when the terminal selects or reselects a cell that does not support the intended slice, the terminal may report, to the base station/network, a slice intended by the terminal and a slice selected when the terminal performs cell selection or reselection (the selected slice may correspond to the default slice or the preferred slice of the terminal).

Alternatively, if it is determined that slice-based cell selection information and/or slice-based cell reselection information is not provided, according to the determination performed in operation 602, the terminal may perform a general conventional cell selection or cell reselection procedure in operation 604. On the other hand, in operation 604, the terminal performing the general conventional cell selection or cell reselection procedure may report the configured slice information configured in the terminal to the base station/network.

In a communication system to which the disclosure can be applied, a terminal may determine the priority of a frequency when performing cell selection or cell reselection, and may determine whether a cell satisfies a cell selection condition with regard to a preferentially selected frequency or whether a cell satisfies a cell reselection condition with regard to the preferentially selected frequency. The slice information intended by the terminal may be applied for the purpose of determining the priority of a frequency at the time of cell selection or cell reselection of the terminal.

If the terminal knows slice and frequency mapping information, the terminal may first select a frequency intended by the terminal itself, and may perform an operation of selecting a cell with regard to the corresponding frequency or an operation of reselecting a cell with regard to the corresponding frequency. When selecting a cell or reselecting a cell with regard to a corresponding frequency, the terminal may determine conditions of a suitable cell, in which the conditions identified by the terminal may include at least one of: identifying whether the cell supports a public land mobile network (PLMN) of the terminal, identifying whether the cell belongs to a forbidden tracking area (TA), identifying whether cell barring occurs, and identifying signal strength conditions, or a combination thereof. For example, if it is determined that the corresponding cell supports the PLMN of the terminal and does not belong to the forbidden TA, cell barring does not occur, and the signal strength has a value equal to or greater than a predetermined threshold value, the terminal may determine that the corresponding cell is a suitable cell. The terminal may select a cell having the largest signal strength among suitable cells.

Meanwhile, a terminal according to an embodiment of the disclosure may use slice information as a condition of selecting or reselecting a cell within a frequency selected according to the priority determination. Here, the frequency selection is to be assumed based on a slice intended by the terminal or based on other conditions. An operation in which the terminal performs cell selection or cell reselection using cell selection-related slice information and cell reselection-related slice information within the selected frequency will be described with reference to FIGS. 6B to 11.

FIG. 6B illustrates a slice-based cell selection operation of a terminal according to an embodiment of the disclosure.

Referring to FIG. 6B, the terminal may acquire at least one of cell selection-related slice information and cell reselection-related slice information or a combination thereof from a network in operation 651. The cell selection-related slice information and cell reselection-related slice information may be acquired through a system information block (SIB) message transmitted by a network or may be obtained through an RRCRelease message. The configuration of cell selection-related slice information and cell reselection-related slice information obtained through a system information block (SIB) message will be described in detail with reference to Tables 2 to 15. The processing of cell reselection-related slice information obtained through the RRCRelease message will be described in detail with reference to Table 17.

In operation 652, the terminal may determine whether a cell selection procedure is being performed or a cell reselection procedure is being performed. If it is determined that the cell selection procedure is performed, the terminal may utilize the cell selection-related slice information obtained in operation 651. If it is determined that the cell reselection procedure is performed, the terminal may utilize the cell reselection-related slice information obtained in operation 651. The terminal performing the cell selection procedure may perform an operation of determining a condition of a suitable cell and acquiring a suitable cell in operation 653. In operation 654, the terminal may perform an operation of determining a condition for selecting a cell from among suitable cells and performing cell selection. The terminal performing the cell reselection procedure may perform an operation of determining a condition of a suitable cell for cell reselection and acquiring a suitable cell in operation 655. In operation 656, the terminal may perform an operation of determining a condition for selection of a cell from among suitable cells for cell reselection and performing cell selection.

Hereinafter, in FIG. 6B, examples of cell selection-related slice information and cell reselection-related slice information obtained by the terminal, an operation example of acquiring a suitable cell by determining a suitable cell selection condition when the terminal performs a cell selection operation and selecting a cell by determining a condition of a cell to be selected, and an operation example of acquiring a suitable cell by determining a suitable cell selection condition when the terminal performs a cell reselection operation and selecting a cell by determining a condition of a cell to be selected will be described. In the embodiments of FIGS. 6B to 11, the terminal may apply, as conditions for determining a suitable cell, at least one of conditions relating to whether the cell supports a PLMN of the terminal, whether the cell belongs to a forbidden TA, whether cell barring occurs, and whether signal strength is satisfied, or a combination thereof. An example in which the terminal utilizes the conditions of determining the suitable cell will be described in each embodiment.

In the embodiment of the disclosure, it is assumed that, when the terminal performs a cell selection operation, slice information related to cell selection in addition to existing cell selection information can be obtained through a system information block (SIB) message transmitted by the base station. In addition, in an embodiment of the disclosure, when the terminal performs a cell reselection operation, it is assumed that cell reselection-related slice information in addition to the existing cell reselection information can be obtained through a system information block (SIB) message transmitted by the base station. On the other hand, this assumption is for convenience of explanation, and the disclosure is not limited thereto. Various configuration information of cell selection-related slice information and cell reselection-related slice information included in the SIB message will be described with reference to Tables 2 to 15.

The terminal performing the cell selection procedure may be configured to determine a suitable cell for cell selection use by applying at least one of PLMN information, forbidden TA information, cell barring information, signal strength, and slice information, or a combination thereof. The terminal performing the cell reselection procedure may be configured to determine a suitable cell for cell reselection use by applying at least one of PLMN information, forbidden TA information, cell barring information, signal strength, and slice information, or a combination thereof.

Examples of determining a suitable cell for cell selection use in the cell selection procedure and determining a suitable cell for cell reselection use in the cell reselection procedure, by the terminal, according to the above configuration are as follows, and the terminal may determine a suitable cell based on one or combinations of the following examples (here, it is assumed that the conditions of PLMN, forbidden TA, and cell barring satisfy the conditions of suitable cells):
(1) In a cell selection procedure or cell reselection procedure according to the configuration, the terminal may determine as to a suitable cell by considering only the signal strength condition regardless of whether a cell supports a slice intended by the terminal itself;
(2) In a cell selection procedure or cell reselection procedure according to the configuration, the terminal may determine as to a suitable cell by considering the signal strength condition only for a cell supporting a slice intended by the terminal itself. For example, when a cell supports a slice intended by the terminal, if a reference signal received power (RSRP) of the cell is equal to or greater than a threshold value, the cell is determined as to the suitable cell;
(3) In a cell selection procedure or cell reselection procedure according to the configuration, the terminal may determine as to a suitable cell by determining whether a cell satisfying the signal strength condition supports a slice intended by the terminal itself. For example, when a RSRP value of a cell is equal to or greater than a threshold value, if the cell supports a slice intended by the terminal, the cell is determined as to the suitable cell; and
(4) In a cell selection procedure or cell reselection procedure according to the configuration, the terminal may determine a cell, which supports a slice intended by the terminal itself, to be a suitable cell without considering a signal strength condition.

As described above, the cell selection configuration in which the terminal selects a cell to camp on from among suitable cells for cell selection use may be configured by at least one of signal strength and slice information or a combination thereof. As described above, the configuration in which the terminal selects a reselection cell from among suitable cells for cell reselection use may be configured by at least one of PLMN information, forbidden TA information, cell barring information, signal strength, and slice information, or a combination thereof. Embodiments in which the terminal selects a cell from among suitable cells for cell selection use in a cell selection procedure and a cell suitable from among suitable cells for cell reselection use in a cell reselection procedure according to the configuration are as follows.

In addition, the terminal may select a cell from among suitable cells based on one of following examples or a combination thereof (under an assumption that the PLMN condition, the forbidden TA condition, and the cell barring condition satisfy the suitable cell condition):
(1) A terminal performing a cell selection procedure or cell reselection procedure according to the configuration may select a cell having the largest signal strength from among suitable cells regardless of slice information;
(2) A terminal performing a cell selection procedure or cell reselection procedure according to the configuration may select a cell supporting a slice intended by the terminal from among suitable cells regardless of a signal strength condition; and
(3) A terminal performing a cell selection procedure or cell reselection procedure according to the configuration may select a cell having the largest signal strength from among suitable cells supporting an intended slice.

When the terminal performs a cell selection procedure or cell reselection procedure, if there is one or more slices supported by a cell and intended by the terminal, the terminal may select a cell by determining whether the cell selection condition is satisfied and whether the cell reselection condition is satisfied in the order of a slice having a high priority to a slice having a low priority by considering the priority of slice intended by the terminal itself and the priority of slice supported by a cell.

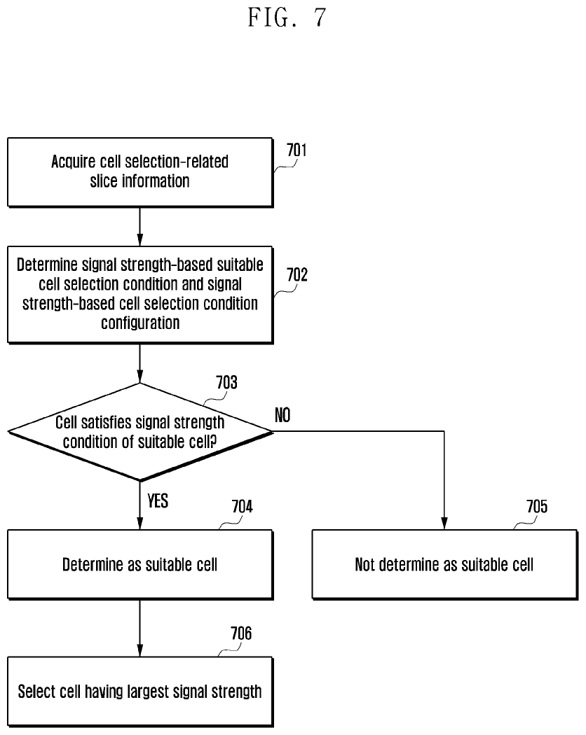

Next, an embodiment of a terminal operation of determining a suitable cell determination condition and a cell selection condition in the cell selection procedure will be described with reference to FIGS. 7 to 11. The embodiment of FIGS. 7 to 11 may be equally applied to a cell reselection procedure (here, it is assumed that the PLMN condition, the forbidden TA condition, and the cell barring condition satisfy the suitable cell condition).

FIG. 7 illustrates an operation in which a terminal performs a cell selection procedure according to various embodiments of the disclosure.

Referring to FIG. 7, in operation 701, the terminal may obtain cell selection-related slice information from a network. In operation 702, the terminal may determine a suitable cell determination condition and a cell selection condition to be applied in the cell selection procedure. In the embodiment of FIG. 7, it is assumed that a signal strength-based suitable cell determination condition is configured and a signal strength-based cell selection condition is configured. In operation 703, the terminal may determine whether a cell satisfies a condition for signal strength of a suitable cell. If it is determined that the cell satisfies the condition for signal strength of the suitable cell, the terminal may determine the corresponding cell as a suitable cell in operation 704. If it is determined that the corresponding cell does not satisfy the condition for signal strength of the suitable cell, the terminal may not select the corresponding cell as a suitable cell in operation 705. In operation 706, the terminal may select a cell having the largest signal strength from among cells determined as suitable cells.

As in the embodiment of FIG. 7, the terminal may acquire and store cell selection-related slice information from the network, but may be configured not to use slice information as a condition for determining a suitable cell and a condition for selecting a cell (a UE can store the information for cell selection in SIBs. The slice information in SIBs is not used for cell selection. NOTE: Priorities between different frequencies or RATs provided to the UE by system information or dedicated signaling are not used in the cell selection process and cell selection by leveraging stored information: For example, the priority of slice is stored but not used in the cell selection process.).

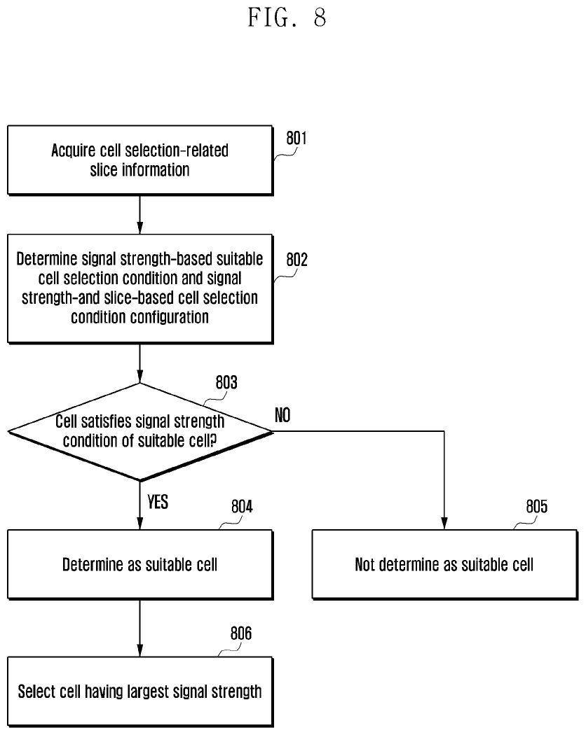

FIG. 8 illustrates an operation in which a terminal performs a cell selection procedure according to various embodiments of the disclosure.

Referring to FIG. 8, in operation 801, the terminal may obtain cell selection-related slice information from a network. In operation 802, the terminal may determine a suitable cell determination condition and a cell selection condition to be applied in the cell selection procedure. In the embodiment of FIG. 8, it is assumed that a signal strength-based suitable cell determination condition is configured and a signal strength- and slice-based cell selection condition is configured. In operation 803, the terminal may determine whether a cell satisfies a condition for signal strength of a suitable cell. If it is determined that the cell satisfies the condition for signal strength of the suitable cell, the terminal may determine the corresponding cell as a suitable cell in operation 804. If it is determined that the corresponding cell does not satisfy the condition for signal strength of the suitable cell, the terminal may not select the corresponding cell as a suitable cell in operation 805. In operation 806, if there is a cell having the largest signal strength and satisfying a slice condition among cells determined as suitable cells, the terminal may select the corresponding cell. In operation 806, if there is a cell having the largest signal strength and does not satisfy the slice condition among cells determined as suitable cells, the terminal may select the corresponding cell. In operation 806, if there is a cell satisfying the slice condition rather than a cell having the largest signal strength among cells determined as suitable cells, the terminal may not select the corresponding cell.

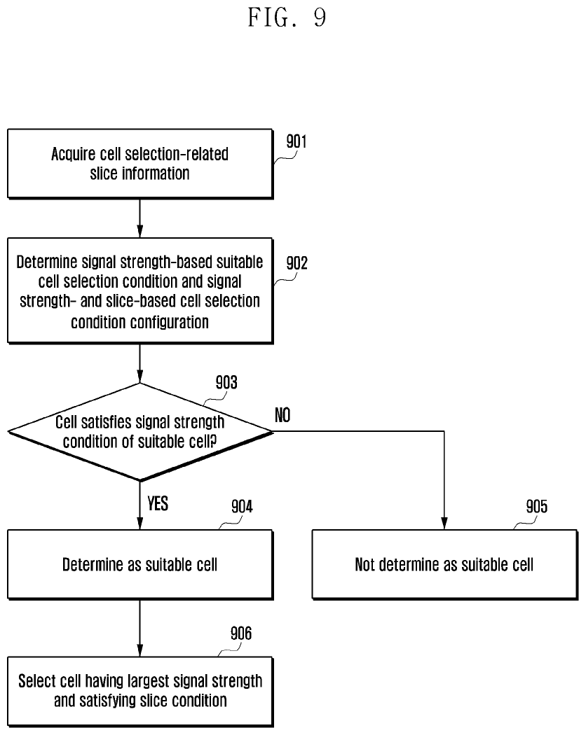

FIG. 9 illustrates an operation in which a terminal performs a cell selection procedure according to various embodiments of the disclosure.

Referring to FIG. 9, in operation 901, the terminal may obtain cell selection-related slice information from a network. In operation 902, the terminal may determine a suitable cell determination condition and a cell selection condition to be applied in the cell selection procedure. In the embodiment of FIG. 9, it is assumed that a signal strength-based suitable cell determination condition is configured and a signal strength- and slice-based cell selection condition is configured. In operation 903, the terminal may determine whether the cell satisfies a condition for signal strength of a suitable cell. If it is determined that the cell satisfies the condition for signal strength of the suitable cell, in operation 904, the terminal may determine the corresponding cell as the suitable cell. If it is determined that the corresponding cell does not satisfy the condition for signal strength of the suitable cell, the terminal may not select the corresponding cell as a suitable cell in operation 905. In operation 906, if there is a cell having the largest signal strength among cells determined as suitable cells and satisfying a slice condition, the terminal may select the corresponding cell. In operation 906, if there is a cell having the largest signal strength among cells determined as suitable cells and does not satisfy the slice condition, the terminal may not select the cell. Here, the terminal that has not selected the cell may continue to perform the cell selection procedure while performing the operation of obtaining the cell selection-related slice information from the network.

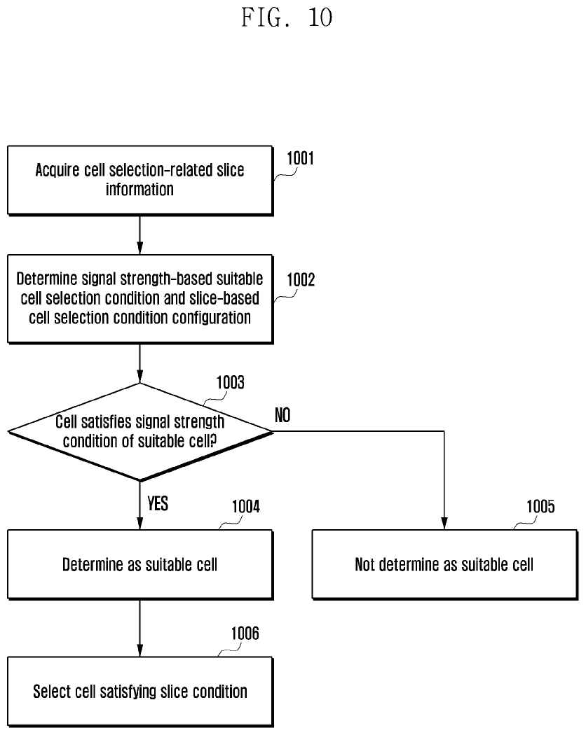

FIG. 10 illustrates an operation in which a terminal performs a cell selection procedure according to various embodiments of the disclosure.

Referring to FIG. 10, in operation 1001, the terminal may obtain cell selection-related slice information from a network. In operation 1002, the terminal may determine a suitable cell determination condition and a cell selection condition to be applied in the cell selection procedure. In the embodiment of FIG. 10, it is assumed that a signal strength-based suitable cell determination condition is configured and a slice-based cell selection condition is configured. In operation 1003, the terminal may determine whether the cell satisfies a condition for signal strength of a suitable cell. If it is determined that the cell satisfies the condition for signal strength of the suitable cell, the terminal may determine the corresponding cell as a suitable cell in operation 1004. If it is determined that the corresponding cell does not satisfy the condition for signal strength of the suitable cell, the terminal may not select the corresponding cell as a suitable cell in operation 1005. In operation 1006, if there is a cell satisfying the slice condition among cells determined as suitable cells, the terminal may select the corresponding cell. In operation 1006, if there is no cell satisfying the slice condition among cells determined as suitable cells, the terminal may not perform cell selection. Here, the terminal that has not perform cell selection may continue to perform the cell selection procedure while performing the operation of obtaining the cell selection-related slice information from the network.

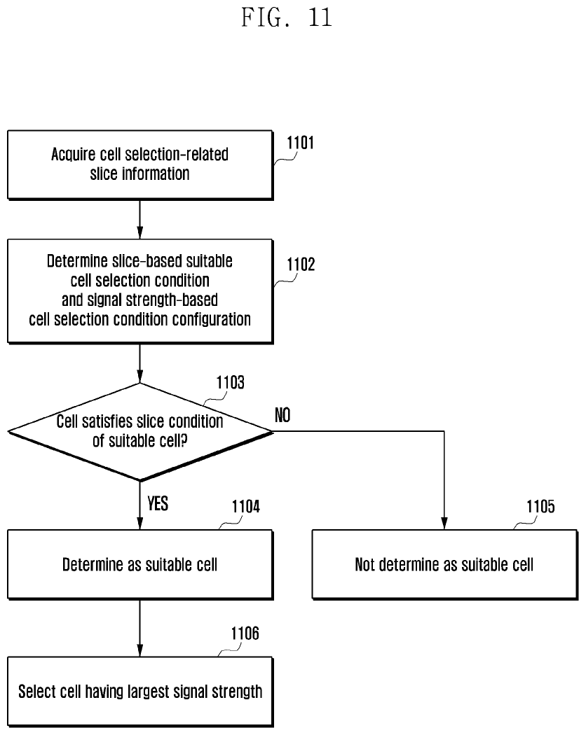

FIG. 11 illustrates an operation in which a terminal performs a cell selection procedure according to various embodiments of the disclosure.

Referring to FIG. 11, in operation 1101, the terminal may obtain cell selection-related slice information from a network. In operation 1102, the terminal may determine a suitable cell determination condition and a cell selection condition to be applied in the cell selection procedure. In the embodiment of FIG. 11, it is assumed that a slice-based suitable cell determination condition is configured and a signal strength-based cell selection condition is configured. In operation 1103, the terminal may determine whether the cell satisfies a slice condition of a suitable cell. If it is determined that the cell satisfies the slice condition of the suitable cell, the terminal may determine the corresponding cell as a suitable cell in operation 1104. If it is determined that the corresponding cell does not satisfy the slice condition of the suitable cell, the terminal may not select the corresponding cell as a suitable cell in operation 1105. In operation 1106, the terminal may select a cell having the largest signal strength from among cells determined as suitable cells.

When the terminal performs a cell selection procedure according to an embodiment of the disclosure, the terminal may determine at least one piece of information of a cell or frequency supporting a slice intended by the terminal itself, a slice priority in the cell or frequency, and the priority of a cell or frequency, or a combination thereof, based on the cell selection-related slice information (e.g., acquired from the configuration information of Tables 2 to 15). When the terminal is to receive a general service without needing to receive support for a specific slice, the terminal may measure a signal strength based on the priority of a cell or frequency as the conventional case (here, the PLMN condition, forbidden TA condition, and cell barring condition are assumed to satisfy the condition of suitable cell).

The terminal may determine a suitable cell according to a result of measuring the signal strength, and may select a cell having the largest signal strength from among suitable cells. When the terminal is to receive service of a specific slice (intended slice of the terminal), the terminal may consider the priority information of a cell or frequency and the slice priority information in a cell or frequency. The terminal may determine, based on the slice priority information in a cell or frequency, whether a slice intended by the terminal itself is supported or the priority of a slice intended by the terminal itself. Here, the terminal may determine a cell or frequency supporting a slice intended by the terminal itself, and may measure the signal strength of the cell or frequency based on the priority of the cell or frequency. The terminal may determine a suitable cell according to a result of signal strength measurement (here, the PLMN condition, forbidden TA condition, and cell barring condition are assumed to satisfy the condition of suitable cell), and may select a cell having the largest signal strength from among suitable cells.

Alternatively, the terminal may determine a cell or frequency that preferentially supports a slice intended by the terminal itself, and may measure the signal strength of the cell or frequency based on the priority of the corresponding cell or frequency. The terminal may determine a suitable cell according to a result of signal strength measurement (here, the PLMN condition, forbidden TA condition, and cell barring condition are assumed to satisfy the condition of suitable cell), and may select a cell having the largest signal strength from among suitable cells.

When the terminal performs a cell reselection procedure according to an embodiment of the disclosure, the terminal may determine at least one piece of information of a cell or frequency supporting a slice intended by the terminal itself, a slice priority in the cell or frequency, and the priority of a cell or frequency, or a combination thereof, based on the cell reselection-related slice information (e.g., acquired from configuration information of Tables 2 to 15 and information of Table 17). When the terminal is to receive a general service without needing to receive support for a specific slice, the terminal may measure the signal strength based on the priority of a cell or frequency as the conventional case.

The terminal may determine a suitable cell according to a result of the signal strength measurement (here, the PLMN condition, forbidden TA condition, and cell barring condition are assumed to satisfy the condition of suitable cell), and may select a cell having the largest signal strength from among suitable cells. When the terminal is to receive a specific slice (corresponding to a slice intended by the terminal), the terminal may consider the priority information of a cell or frequency and the slice priority information in a cell or frequency. The terminal may determine, based on the slice priority information in a cell or frequency, whether a slice intended by the terminal itself is supported or the priority of a slice intended by the terminal itself.

Here, the terminal may determine a cell or frequency supporting a slice intended by the terminal itself, and may measure the signal strength of the cell or frequency based on the priority of the cell or frequency. The terminal may determine a suitable cell according to a result of signal strength measurement (here, the PLMN condition, forbidden TA condition, and cell barring condition are assumed to satisfy the condition of suitable cell), and may select a cell having the largest signal strength from among suitable cells.

Alternatively, the terminal may determine a cell or frequency that preferentially supports a slice intended by the terminal itself, and may measure the signal strength of the cell or frequency based on the priority of the corresponding cell or frequency. The terminal may determine a suitable cell according to a result of signal strength measurement (here, the PLMN condition, forbidden TA condition, and cell barring condition are assumed to satisfy the condition of suitable cell), and may select a cell having the largest signal strength from among suitable cells.

On the other hand, according to various embodiments of the disclosure, when it is determined that a cell selected by the terminal according to a cell selection condition cannot support a slice intended by the terminal, a terminal operation is as follows.

A default slice may be configured as one of the configured slices of the terminal. A slice required when the terminal selects a cell in a cell selection procedure or a cell reselection procedure may include a default slice. When a default slice is configured, the terminal may receive support for a PDU session corresponding to the default slice. In general, an enhanced mobile broadband (eMBB) service slice may be configured as a default slice, and it is needless to say that a slice corresponding to another service may also be configured as a default slice.

When the terminal selects a cell and determines to use a default slice, the following example may be considered.

In one example, when it is determined that a cell, which is selected according to a cell selection/reselection condition (e.g., selection of a cell having the highest signal strength), does not support a slice required by the terminal, the terminal may be provided with a default slice through the selected cell.

In one example, when it is determined that that a cell, which is selected according to a suitable cell selection/reselection condition (e.g., selection of a cell having an RSRP value equal to or greater than a threshold value), does not support a slice required by the terminal, the terminal may select a cell having the largest signal strength among suitable cells and may be provided with a default slice through the selected cell.

As an embodiment of the disclosure, when the terminal selects a cell which may provide a default slice and performs an access procedure, a random access channel (RACH) parameter configured for the default slice may be used. As another embodiment, when the terminal selects a cell which may provide a default slice and performs an access procedure, a slice specific RACH parameter may be used.

In one example, if a default slice is configured for the terminal and it is determined that the selected cell supports the default slice, the terminal may perform packet transmission and reception corresponding to the default slice in the selected cell. Here, the selected cell corresponds to a cell having the largest signal strength. The terminal may report at least one of slice information intended by the terminal itself and slice information (default slice information) selected when the terminal performs cell selection or a combination thereof to a base station/network through, for example, an RRCSetupComplete message, while performing a connection procedure in the selected cell.

In one example, if a default slice is configured for the terminal and it is determined that the selected cell supports the default slice as a preferred slice, the terminal may perform packet transmission/reception corresponding to the default slice in the selected cell. The terminal may report at least one of slice information intended by the terminal itself and slice information (default slice information) selected when the terminal performs cell selection or a combination thereof to a base station/network through, for example, an RRCSetupComplete message, while performing a connection procedure in the selected cell.

In one example, if a default slice is configured for the terminal and the default slice supported by the selected cell does not correspond to the default slice of the terminal, the terminal may not select the corresponding cell.

In one example, if a default slice is configured for the terminal and the default slice supported by the selected cell does not correspond to the default slice of the terminal, the terminal may determine that a general access procedure may be performed through the corresponding cell. The terminal may report slice information intended by the terminal itself to the base station/network through, for example, an RRCSetupComplete message, while performing a connection procedure in the selected cell.

According to various embodiments of the disclosure, a network may configure preferred slice information in a cell or frequency and provide the same to the terminal through a system information block (SIB) message. A slice intended by the terminal may be included in a preferred slice, and a slice intended by the terminal may not be included in a preferred slice. A slice intended by the terminal may not be included in the preferred slice, but a default slice configured for the terminal may be included in the preferred slice. The terminal may select a cell based on signal strength and slice information according to the configured cell selection condition or cell reselection condition described above, including a preferred slice. If it is determined that a slice intended by the terminal is not included in the preferred slice, the terminal may not select the corresponding cell. If it is determined that a slice intended by the terminal is not included in the preferred slice, the terminal may determine that a general access procedure can be performed through the corresponding cell.

The terminal may report information of a slice intended by the terminal itself to the base station/network through, for example, an RRCSetupComplete message, while performing a connection procedure in the selected cell. If it is determined that a slice intended by the terminal is not included in a preferred slice but the default slice configured for the terminal is included in a preferred slice, the terminal may determine that the default slice can be provided through the corresponding cell, and may select the corresponding cell in order to perform a default slice service. The terminal may report at least one of slice information intended by the terminal itself and slice information (default slice information) selected when the terminal performs cell selection or a combination thereof, to the base station/network through, for example, an RRCSetupComplete message, while performing a connection procedure in the cell selected for the default slice service.

According to an embodiment of the disclosure, cell selection information including slice information obtained by a terminal from a base station and cell reselection information including slice information may be configured as follows. Slice information of the following examples 1, 2, and 3 may include at least one of default slice configuration information and preferred slice configuration information or a combination thereof.

In one example of 1, at least one of cell selection information of a serving cell, cell reselection information of a serving cell, cell selection information of a serving cell inter-frequency, and cell reselection information of a serving cell inter-frequency, or a combination thereof. The above information may include, for example, the following pieces of information.

Slice related priority info for serving cell, serving cell frequency or serving cell frequencies: list of frequency priority, and list of NSSAI (slice identifier) of serving cell frequency (incl. default slice)

Signal strength condition, PLMN information, TA information, cell barring information.

In one example of 2, cell selection information of a neighboring cell, neighboring cell reselection information, cell selection information of a neighboring cell intra-frequency, cell reselection information of a neighboring cell intra-frequency, cell selection information of a neighboring cell inter-frequency, and cell reselection information of a neighboring cell inter-frequency, or a combination thereof. The pieces of information may include, for example, the following pieces of information. -Slice related priority info for neighboring cell, neighboring cell frequency(frequencies): list of frequency priority, and list of NSSAI (slice identifier) of neighboring cell frequency (incl. default slice).

The information may be configured as follows, for example:

slice0fIntraFreqNeighboringCell SEQUENCE (SIZE (1 . . . maxSlice)) OF Slice0fInfraFreqNeighboringCell; and/or

slice0fInterFreqNeighboringCell SEQUENCE (SIZE (1 . . . maxSlice)) OF Slice0fInterFreqNeighboringCell.

Signal strength condition, PLMN information, TA information, cell barring information.

In one example of 3, at least one of PLMN specific slice and PLMN common slice or a combination thereof.

The configuration of a system information block message (SIB) including the slice information and cell selection information, and slice information and cell reselection information is as follows. SIB1, SIB2, SIB3, SIB4, and SIB5 defined in a radio access network new radio system according to 5G mobile communication standard may include cell selection information and cell reselection information for a serving cell, the same frequency, a neighboring frequency, a neighboring cell, and a heterogeneous RAT, which are usable by the terminal. According to an embodiment of the disclosure, SIB1, SIB2, SIB3, SIB4, and SIB5 may be configured to include slice information that can be supported by the serving cell, the same frequency, a neighboring frequency, a neighboring cell, and a heterogeneous RAT, respectively, as shown in Table 2 below. As another embodiment, the information in Table 2 may be configured as a separate SIB from SIB1, SIB2, SIB3, SIB4, and SIB5, and the terminal may acquire the same.

TABLE 2
SIB1: slice related info in serving cell (cell selection)
List of NSSAI of serving cell frequency, cell selection info
SIB2: slice related info in serving cell (cell reselection)
List of NSSAI of serving cell frequency + cell reselection info for
slice/frequency
List of NSSAI of serving cell frequency, common cell reselection info for
any slice info
SIB3: slice related info in neighboring cells (cell reselection)
List of neighboring cell, list of NSSAI of neighboring cell + cell
reselection info for slice/neighboring cell
List of neighboring cell, list of NSSAI of neighboring cell, common cell
reselection info for any slice info
SIB4: slice related info in neighboring cells (cell reselection)
List of neighboring cell, list of inter frequency, list of NSSAI + cell
reselection info for slice/inter frequency/neighboring cell
List of neighboring cell, list of inter frequency, list of NSSAI, common
cell reselection info for any slice info
SIB5: slice related info in inter-RAT (cell reselection)

According to various embodiments of the disclosure, the configuration of cell selection slice information of a serving cell may include examples of Tables 3 to 5.

TABLE 3
SIB1 ::= SEQUENCE {
...

| | |
|---|---|
| SlicePriorityListNR | SEQUENCE { |

| | |
|---|---|
| slice-PriorityCommon | Slice-PrioirtyNR OPTIONAL, |
| slice-PriorityPLMN | Slice-PriorityNR OPTIONAL |

} OPTIONAL
}
SlicePriorityNR ::= SEQUENCE {

| | |
|---|---|
| nSSAI | NSSAI, //one example of slice identifier |

priority Priority OPTIONAL //access priority of the slice in the carrier
}

TABLE 4

| | |
|---|---|
| PLMN-IdentityInfoList ::= | SEQUENCE (SIZE (1..maxPLMN)) OF PLMN- |

IdentityInfo

| | |
|---|---|
| PLMN-IdentityInfo ::= | SEQUENCE { |
| plmn-IdentityList | SEQUENCE (SIZE (1..maxPLMN)) OF PLMN-Identity, |
| trackingAreaCode | TrackingAreaCode OPTIONAL, -- Need R |

| | |
|---|---|
| ranac | RAN-AreaCode OPTIONAL, -- Need R |

| | |
|---|---|
| cellIdentity | CellIdentity, |
| cellReservedForOperatorUse | ENUMERATED {reserved, notReserved}, |

...,

| | |
|---|---|
| slicePriorityListNR | SEQUENCE (SIZE (1..maxSlice)) OF SlicePriorityNR |

}

| | |
|---|---|
| SlicePriorityNR ::= | SEQUENCE { |

| | |
|---|---|
| nSSAI | NSSAI, //one example of slice identifier |

priority Priority OPTIONAL //access priority of the slice in the carrier
}

TABLE 5

| | |
|---|---|
| CellAccessRelatedInfo ::= | SEQUENCE { |
| plmn-IdentityList | PLMN-IdentityInfoList, |
| cellReservedForOtherUse | ENUMERATED {true} |

```
OPTIONAL, -- Need R
  ...,
SlicePriorityListNR SEQUENCE (SIZE (1..maxSlice)) OF
SlicePriorityNR
}
SlicePriorityNR ::= SEQUENCE {
      nSSAI NSSAI, //one example of slice identifier
      priority Priority OPTIONAL //access priority of the slice in the
      carrier
}
```

According to various embodiments of the disclosure, slice cell selection and cell reselection information that can be supported at the inter-frequency of a serving cell may be configured as shown in the examples of Tables 6 to 9 below.

TABLE 6

| | |
|---|---|
| SlicePriorityListNR | SEQUENCE (SIZE (1..maxSlice)) OF |
| | SlicePriorityNR |
| SlicePriorityNR ::= | SEQUENCE { |
| nSSAI | NSSAI, // one example of slice identifier |

```
      priority Priority OPTIONAL, //access priority of the slice in the
      carrier
```

| | |
|---|---|
| listCarrierFreq | //list of ARFCN-ValueNR or frequencyBandList |

}

```
TABLE 7
cellReselectionInfoCommon SEQUENCE {
    nrofSS-BlocksToAverage INTEGER (2..maxNrofSS-BlocksToAverage)
OPTIONAL, -- Need S
    absThreshSS-BlocksConsolidation ThresholdNR OPTIONAL, -- Need S
    rangeToBestCell RangeToBestCell OPTIONAL, -- Need R
    q-Hyst ENUMERATED {dB0, dB1, dB2, dB3, dB4, dB5, dB6, dB8, dB10,
dB12, dB14, dB16, dB18, dB20, dB22, dB24},
    speedStateReselectionPars SEQUENCE {
      mobilityStateParameters MobilityStateParameters,
      q-HystSF SEQUENCE {
        sf-Medium ENUMERATED {dB-6, dB-4, dB-2, dB0},
        sf-High ENUMERATED {dB-6, dB-4, dB-2, dB0}
      }
    } OPTIONAL, -- Need R
  ...
    SlicePriorityListNR SEQUENCE (SIZE (1..maxSlice)) OF SlicePriorityNR
  },
  cellReselectionServingFreqInfo SEQUENCE {
    s-NonIntraSearchP ReselectionThreshold OPTIONAL, -- Need
S
    s-NonIntraSearchQ ReselectionThresholdQ OPTIONAL, --
Need S
    threshServingLowP ReselectionThreshold,
    threshServingLowQ ReselectionThresholdQ OPTIONAL, --
Need R
    cellReselectionPriority CellReselectionPriority,
    cellReselectionSubPriority CellReselectionSubPriority OPTIONAL, --
Need R
    ...
  },
SlicePriorityNR ::= SEQUENCE {
  nSSAI NSSAI, //one example of slice identifier
  priority Priority OPTIONAL, //access priority of the slice in the carrier
  listCarrierFreq //list of ARFCN-ValueNR or frequencyBandList
}
According to an embodiment of the disclosure, if slicePriorityListNR is present, UE can
ignore cell reselection priority/subpriority.
```

```
TABLE 8
intraFreqCellReselectionInfo SEQUENCE {
      q-RxLevMin Q-RxLevMin,
      q-RxLevMinSUL Q-RxLevMin OPTIONAL, -- Need R
      q-QualMin Q-QualMin OPTIONAL, -- Need S
      s-IntraSearchP ReselectionThreshold,
      s-IntraSearchQ ReselectionThresholdQ OPTIONAL, -- Need S
      t-ReselectionNR T-Reselection,
      frequencyBandList MultiFrequencyBandListNR-SIB OPTIONAL, --
Need S
      frequencyBandListSUL MultiFrequencyBandListNR-SIB OPTIONAL, --
Need R
      p-Max P-Max OPTIONAL, -- Need S
      smtc SSB-MTC OPTIONAL, -- Need S
      ss-RSSI-Measurement SS-RSSI-Measurement OPTIONAL, --
Need R
      ssb-ToMeasure SSB-ToMeasure OPTIONAL, -- Need S
      deriveSSB-IndexFromCell BOOLEAN,
  ...
      slicePriorityListNR SEQUENCE (SIZE (1..maxSlice)) OF SlicePriorityNR
},
SlicePriorityNR ::= SEQUENCE {
    nSSAI NSSAI, //one example of slice identifier
    priority Priority OPTIONAL //access priority of the slice in the carrier
}
```

```
TABLE 9
cellReselectionInfoCommon SEQUENCE {
    nrofSS-BlocksToAverage INTEGER (2..maxNrofSS-BlocksToAverage)
OPTIONAL, -- Need S
    absThreshSS-BlocksConsolidation ThresholdNR
OPTIONAL, -- Need S
    rangeToBestCell  RangeToBestCell OPTIONAL, -- Need
R
    q-Hyst ENUMERATED {dB0, dB1, dB2, dB3, dB4, dB5, dB6, dB8,
dB10, dB12, dB14, dB16, dB18, dB20, dB22, dB24},
    speedStateReselectionPars SEQUENCE {
      mobilityStateParameters MobilityStateParameters,
      q-HystSF SEQUENCE {
        sf-Medium ENUMERATED {dB-6, dB-4, dB-2, dB0},
        sf-High ENUMERATED {dB-6, dB-4, dB-2, dB0}
      }
    } OPTIONAL, -- Need R
  },
cellReselectionServingFreqInfo SEQUENCE {
    s-NonIntraSearchP ReselectionThreshold OPTIONAL, -- Need S
    s-NonIntraSearchQ ReselectionThresholdQ OPTIONAL, -- Need S
    threshServingLowP ReselectionThreshold,
    threshServingLowQ ReselectionThresholdQ OPTIONAL, -- Need R
    cellReselectionPriority CellReselectionPriority,
    cellReselectionSubPriority CellReselectionSubPriority OPTIONAL, --
Need R
    ...
    SlicePriorityListNR SEQUENCE (SIZE (1..maxSlice)) OF SlicePriorityNR
  },
SlicePriorityNR ::= SEQUENCE {
  nSSAI NSSAI, //one example of slice identifier
  priority Priority OPTIONAL, //access priority of the slice in the carrier
  listCarrierFreq //list of ARFCN-ValueNR or frequencyBandList
}
intraFreqCellReselectionInfo SEQUENCE {
  ...
}
According to an embodiment of the disclosure, if SlicePriorityListNR is present, UE can
ignore cell reselection priority/subpriority.
```

According to various embodiments of the disclosure, slice cell selection and cell reselection information that can be supported at the intra-frequency of a neighboring cell may be configured as shown in the examples of Tables 10 to 11 below.

TABLE 10

| | |
|---|---|
| IntraFreqNeighCellInfo ::= | SEQUENCE { |
| physCellId | PhysCellId, |
| q-OffsetCell | Q-OffsetRange, |
| q-RxLevMinOffsetCell | INTEGER (1..8) OPTIONAL, -- |

Need R

| | |
|---|---|
| q-RxLevMinOffsetCellSUL | INTEGER (1..8) OPTIONAL, -- |

Need R

| | |
|---|---|
| q-QualMinOffsetCell | INTEGER (1..8) OPTIONAL, -- Need |

```
R
  ...
  SlicePriorityListNR SEQUENCE (SIZE (1..maxSlice)) OF
  SlicePriorityNR
}
SlicePriorityNR ::= SEQUENCE {
    nSSAI NSSAI, //an example of slice identifier
    priority Priority OPTIONAL //access priority of the slice in the
    carrier
}
```

TABLE 11

```
SIB3 ::= SEQUENCE {
  intraFreqNeighCellList IntraFreqNeighCellList OPTIONAL,
  -- Need R
  intraFreqBlackCellList IntraFreqBlackCellList OPTIONAL,
  -- Need R
  lateNonCriticalExtension OCTET STRING
OPTIONAL,
  ...,
  SlicePriorityListNR SEQUENCE (SIZE (1..maxSlice)) OF
  SlicePriorityNR
}
SlicePriorityNR ::= SEQUENCE {
    nSSAI NSSAI, //an example of slice identifier
    priority Priority OPTIONAL //access priority of the slice in the
    carrier
  }
```

According to various embodiments of the disclosure, slice cell selection and cell reselection information that can be supported at the inter-frequency of a neighboring cell may be configured as shown in the examples of Tables 12 to 14 below.

```
TABLE 12
InterFreqCarrierFreqInfo ::= SEQUENCE {
  dl-CarrierFreq ARFCN-ValueNR,
  frequencyBandList MultiFrequencyBandListNR-SIB OPTIONAL, -- Cond
Mandatory
  frequencyBandListSUL MultiFrequencyBandListNR-SIB OPTIONAL, --
Need R
  nrofSS-BlocksToAverage INTEGER (2..maxNrofSS-BlocksToAverage)
OPTIONAL, -- Need S
```

| | |
|---|---|
| absThreshSS-BlocksConsolidation | ThresholdNR OPTIONAL, -- Need |

```
S
  smtc SSB-MTC OPTIONAL, -- Need S
  ssbSubcarrierSpacing SubcarrierSpacing,
```

| | |
|---|---|
| ssb-ToMeasure SSB-ToMeasure | OPTIONAL, -- Need S |

```
  deriveSSB-IndexFromCell BOOLEAN,
  ss-RSSI-Measurement SS-RSSI-Measurement OPTIONAL,
  q-RxLevMin Q-RxLevMin,
```

| | |
|---|---|
| q-RxLevMinSUL Q-RxLevMin | OPTIONAL, -- Need R |
| q-QualMin Q-QualMin | OPTIONAL, -- Need S |
| p-Max P-Max | OPTIONAL, -- Need S |

```
  t-ReselectionNR T-Reselection,
  t-ReselectionNR-SF SpeedStateScaleFactors OPTIONAL, -- Need S
  threshX-HighP  ReselectionThreshold,
  threshX-LowP ReselectionThreshold,
  threshX-Q SEQUENCE {
    threshX-HighQ ReselectionThresholdQ,
    threshX-LowQ ReselectionThresholdQ
  } OPTIONAL, -- Cond RSRQ
  cellReselectionPriority CellReselectionPriority OPTIONAL, -- Need R
  cellReselectionSubPriority CellReselectionSubPriority OPTIONAL, --
Need R
```

| | |
|---|---|
| q-OffsetFreq | Q-OffsetRange DEFAULT |

```
dB0,
  interFreqNeighCellList InterFreqNeighCellList OPTIONAL, -- Need
R
  interFreqBlackCellList InterFreqBlackCellList OPTIONAL, -- Need R
  ...
}
InterFreqNeighCellInfo ::= SEQUENCE {
```

| | |
|---|---|
| physCellId | PhysCellId, |
| q-OffsetCell | Q-OffsetRange, |
| q-RxLevMinOffsetCell | INTEGER (1..8) OPTIONAL, -- |

Need R

| | |
|---|---|
| q-RxLevMinOffsetCellSUL | INTEGER (1..8) OPTIONAL, -- |

Need R

| | |
|---|---|
| q-QualMinOffsetCell | INTEGER (1..8) OPTIONAL, -- Need |

```
R
  ...
  SlicePriorityListNR SEQUENCE (SIZE (1..maxSlice)) OF SlicePriorityNR
}
SlicePriorityNR ::= SEQUENCE {
    nSSAI NSSAI, //an example of slice identifier
    priority Priority OPTIONAL, //access priority of the slice in the carrier
}
```

```
TABLE 13
InterFreqCarrierFreqInfo ::= SEQUENCE {
  dl-CarrierFreq ARFCN-ValueNR,
  frequencyBandList MultiFrequencyBandListNR-SIB OPTIONAL, --
Cond Mandatory
  frequencyBandListSUL MultiFrequencyBandListNR-SIB  OPTIONAL,
-- Need R
  nrofSS-BlocksToAverage INTEGER (2..maxNrofSS-BlocksToAverage)
OPTIONAL, -- Need S
  absThreshSS-BlocksConsolidation ThresholdNR OPTIONAL, -- Need
S
  smtc SSB-MTC OPTIONAL, -- Need S
  ssbSubcarrierSpacing SubcarrierSpacing,
  ssb-ToMeasure SSB-ToMeasure OPTIONAL, -- Need S
  deriveSSB-IndexFromCell BOOLEAN,
  ss-RSSI-Measurement SS-RSSI-Measurement OPTIONAL,
  q-RxLevMin Q-RxLevMin,
  q-RxLevMinSUL Q-RxLevMin OPTIONAL, -- Need R
  q-QualMin Q-QualMin OPTIONAL, -- Need S
  p-Max P-Max OPTIONAL, -- Need S
  t-ReselectionNR T-Reselection,
  t-ReselectionNR-SF SpeedStateScaleFactors OPTIONAL, -- Need S
  threshX-HighP  ReselectionThreshold,
  threshX-LowP ReselectionThreshold,
  threshX-Q SEQUENCE {
    threshX-HighQ ReselectionThresholdQ,
    threshX-LowQ ReselectionThresholdQ
  } OPTIONAL, -- Cond RSRQ
  cellReselectionPriority CellReselectionPriority OPTIONAL, -- Need R
  cellReselectionSubPriority CellReselectionSubPriority OPTIONAL, --
Need R
  q-OffsetFreq Q-OffsetRange DEFAULT dB0,
  interFreqNeighCellList InterFreqNeighCellList OPTIONAL, -- Need R
  interFreqBlackCellList InterFreqBlackCellList OPTIONAL, -- Need R
  ...
  SlicePriorityListNR SEQUENCE (SIZE (1..maxSlice)) OF SlicePriorityNR
}
SlicePriorityNR ::= SEQUENCE {
    nSSAI NSSAI, //an example of slice identifier
    priority Priority OPTIONAL //access priority of the slice in the carrier
}
According to an embodiment of the disclosure, if slicePriorityListNR is present, UE can
ignore cell reselection priority/subpriority.
```

In the embodiments of Tables 2 to 13, the slice configuration information obtained as cell selection information or cell reselection information may be configured as: (1) the priority of frequency that can be supported for each slice (priority order of frequency per slice) or (2) the priority of slice that can be supported for each frequency (priority order of slice per frequency). As another embodiment, (1) and (2) may be configured in combination with the applied area info. If RAN notification area is described as an example, the terminal may acquire configuration information of (1) or (2) applied in RAN notification area A and configuration information of (1) or (2) applied in RAN notification area B, respectively. Table 14 shows an example of the configuration information of (1), and Table 15 shows an example of the configuration information of (2). The information of (1) or (2) may be used to determine the frequency priority when the terminal performs cell reselection. That is, the information of (1) or (2) may be used to determine a frequency supporting a slice intended by a terminal, and may be used to preferentially select the corresponding frequency when supporting the slice intended by the terminal.

TABLE 14

```
SlicePriorityListNR ::= SEQUENCE (SIZE (1..maxSlice)) OF
SlicePriorityNR
SlicePriorityNR ::= SEQUENCE {
  nSSAI NSSAI, //an example of slice identifier
  listCarrierFreq //list of ARFCN-ValueNR (this can be listed in
priority order (implicit) or this can contain explicit priority of
corresponding frequency)
}
```

TABLE 15

```
FreqPriorityListNR ::= SEQUENCE (SIZE (1..maxFreq)) OF
FreqPriorityNR
FreqPriorityNR ::= SEQUENCE {
  carrierFreq ARFCN-ValueNR,
  nSSAI SEQUENCE of {NSSAI}(this can be listed in
priority order (implicit) or this can contain explicit priority of
corresponding frequency)
}
```

NSSAI, which is used as slice identification information in the embodiments of Tables 2 to 15, may be noted as at least one of SST of a slice, SST+ slice differentiator (SD) of a slice, a slice group identifier to which a slice belongs, and an index corresponding to a slice, or a combination thereof. When the terminal knows the configured slice information and the base station also knows the configured slice information of the terminal, the NSSI indicates an index of the corresponding slice among the configured slices. When the terminal knows the allowed slice information and the base station also knows the allowed slice information of the terminal, the NSSI indicates an index of the corresponding slice among the allowed slices.

As an embodiment of the disclosure, the network may map access category information and slice information and configure, in the terminal, a cell barring procedure for a slice, cell selection-related slice information, or cell reselection-related slice information. Examples of cell barring configuration, cell selection configuration, and cell reselection configuration for a slice which the terminal acquires from the network are shown in Table 16. The cell selection configuration and the cell reselection configuration of Table 16 may be configured to be included in at least one of the system information blocks of Tables 2 to 15.

```
TABLE 16
UAC-BarringPerCat ::= SEQUENCE {
  accessCategory INTEGER (1..maxAccessCat−1),
  uac-barringInfoSetIndex UAC-BarringInfoSetIndex
}
UAC-BarringInfoSetList ::= SEQUENCE (SIZE(1..maxBarringInfoSet)) OF UAC-
BarringInfoSet
UAC-BarringInfoSet ::= SEQUENCE {
    uac-BarringFactor ENUMERATED {p00, p05, p10, p15, p20, p25, p30, p40, p50,
p60, p70, p75, p80, p85, p90, p95},
    uac-BarringTime ENUMERATED {s4, s8, s16, s32, s64, s128, s256, s512},
  uac-BarringForAccessIdentity BIT STRING (SIZE(7))
}
```

A part of the accessCategory parameter of Table 16 may be configured to be mapped to a slice (S-NSSAI). When mapped to a slice, one of 32 or 63 of the access category values may be used. UAC-BarringPerCat may be used for configuration of cell barring for a slice or configuration of a slice related to cell selection/cell reselection. When UAC-BarringPerCat is used for configuration of cell barring for a slice, uac-barringInfoSetIndex may be used to indicate barring information to be applied to the slice by configuring the value of uac-BarringInfoSetList. When UAC-BarringPerCat is used for configuration of cell selection/reselection-related slice, uac-barringInfoSetIndex may configure a value not included in uac-BarringInfoSetList so as to indicate that this slice is supported in the cell or frequency instead of being used for cell barring.

The terminal operation of determining cell selection/reselection-related slice information or determining cell barring for a slice according to the accessCategory of UAC-BarringPerCat and the configuration information of uac-barringInfoSetIndex is as example followings.

In one example, if it is determined that accessCategory of UAC-BarringPerCat corresponds to a slice intended by the terminal, and uac-barringInfoSetIndex of the corresponding accessCategory is configured to be a value not included in the uac-BarringInfoSetList, the terminal may determine that this cell or frequency can support the corresponding slice. That is, the terminal may determine that this information is slice-related cell selection or cell reselection information. This information may be used by the terminal in the cell selection procedure or the cell reselection procedure described above. For example, the terminal may perform the cell selection procedure or the cell reselection procedure of FIG. 6B by using cell selection information, cell reselection information, signal strength-based cell selection information, and signal strength-based cell reselection information, which are acquired from UAC-BarringPerCat according to cell selection condition configuration or cell reselection condition configuration.

In one example, if it is determined that accessCategory of UAC-BarringPerCat corresponds to a slice intended by the terminal, and uac-barringInfoSetIndex of the corresponding accessCategory is configured to be one of the values included in the uac-BarringInfoSetList, the terminal may determine that cell barring is applied to the corresponding slice, and may apply the selected UAC-BarringInfoSet, as a “UAC barring parameter”, to cell barring of the corresponding slice.

In one example, if it is determined that accessCategory of UAC-BarringPerCat does not include slice information intended by the terminal, the terminal may determine that the corresponding cell or frequency does not support a slice intended by the terminal. The terminal may not select the corresponding cell. Alternatively, when a corresponding cell is selected, the terminal may perform a connection procedure and perform an operation of reporting the intended slice information (transmission of the RRCSetupComplete message) through the corresponding cell. As another embodiment, when it is determined that the corresponding cell or frequency supports a default slice of the terminal, the terminal may select the corresponding cell and perform a connection procedure, and may perform an operation of reporting (transmission of the RRCSetupComplete message) at least one of the intended slice information and default slice information used by the terminal at the time of cell selection.

An operation of a network supporting cell selection and cell reselection operations of a slice-based terminal according to various embodiments of the disclosure is as follows. The network may perform handover a terminal, which has performed a connection procedure by selecting or reselecting a cell, to another frequency or another cell, configure CA on the same, or configure DC on the same according to the slice policy of a network, and may provide a slice service (RRCReconfiguration message) according to the slice policy of the network to the corresponding terminal. The slice, which is provided to the terminal according to the handover or the CA or DC configuration may be different from slice information configured in a system information block (SIB) message.

In addition, the network may redirect the terminal to another frequency or another cell according to the slice policy of the network, and may provide (RRCRelease) a slice service according to the slice policy of the network to the corresponding terminal. The slice provided to the terminal according to the redirection configuration may be different from slice information configured in a system information block (SIB) message. When the base station/network redirects or handover the terminal to another frequency or other cell, configures CA on the same, or configures DC on the same, if at least one of slice information intended by the terminal and slice information (e.g., a default slice) selected by the terminal when performing cell selection is reported from the terminal, the base station/network may transfer the slice information intended by the terminal or the slice information selected by the terminal to a base station/network of another frequency or another cell through an inter-node message.

Table 17 below shows an example of an operation of a terminal having obtained a redirection configuration including cell reselection-related slice information from a network. The terminal may receive an RRCRelease message from the network and determine whether the RRCRelease message includes cell reselection-related slice information. The terminal may store cell reselection-related slice information. If it is determined that the RRCRelease message includes information of t320 timer, the terminal may configure T320 as a value of the information of t320 timer and start the T320 timer. If it is determined that the T320 timer has not expired when the terminal performs the cell reselection operation, the terminal may perform the cell reselection operation by using the cell reselection-related slice information acquired from the RRCRelease message.

If it is determined that the T320 timer has expired when the terminal performs a cell reselection operation, the terminal may acquire cell reselection-related slice information from the system information block message, and may perform a cell reselection operation by using cell reselection-related slice information acquired from the system information block message. If the terminal obtains the RRCRelease message from the network but the RRCRelease message does not include cell reselection-related slice information, the terminal may acquire cell reselection-related slice information from the system information block message, and may perform a cell reselection operation by using cell reselection-related slice information acquired from the system information block message. An example of an operation in which the terminal performs a cell reselection operation by using the cell reselection-related slice information from the RRCRelease message or the system block message is shown in FIG. 6B.

```
TABLE 17
1> if the RRCRelease message includes the cellReselectionPriorities:
  2> store the (slice specific) cell reselection priority information provided
by the cellReselectionPriorities;
  2> if the t320 is included:
  3> start timer T320, with the timer value set according to the value of
  t320;
1> else:
  2> apply the (slice specific) cell reselection priority information provided
in the slice specific SIB; //slice specific SIB is the embodiments of Table 2
to Table 15
```

The terminal may perform a cell reselection measurement procedure based on slice-related cell selection/cell reselection configuration information acquired from a network, for example, through a system information block message, while performing an RRC connection establishment procedure. When it is determined that a new suitable cell supporting a slice intended by the terminal exists while the T300 timer is being performed, the terminal may configure a release code to be “RRC Connection Failure” and perform a procedure of transitioning to the RRC_IDLE state, as an embodiment. When it is determined that a new suitable cell supporting a slice intended by the terminal exists while the T300 timer is being performed, the terminal may configure the release code to be “other” and perform a procedure of transitioning to the RRC_IDLE state, as another embodiment.

Next, a method for configuring a random access channel (RACH) resource for a specific slice or a specific slice group will be described. One slice group may include one or a plurality of slices. If an RACH resource mapped to the slice or slice group is configured, the terminal may perform a random access procedure by using the RACH resource mapped to the intended slice or the intended slice group. Here, the RACH resource may include at least one of a PRACH preamble, a RACH occasion (RO), etc. used in the random access procedure.

According to an embodiment, the RACH resource configuration corresponding to a slice or a slice group may always include a PRACH configuration index (prach-ConfigurationIndex). SSB-SharedRO-MaskIndex may optionally be included in the RACH resource configuration, and when this information is included, the SSB-SharedRO-MaskIndex may be used to indicate the subset of RO indicated by the PRACH configuration index of the RACH resource configuration corresponding to the slice or slice group, and the corresponding slice or slice group may use the indicated subset of RO. If the SSB-SharedRO-MaskIndex is not included in the RACH resource configuration, this indicates that the terminal may use all ROs indicated by the PRACH configuration index of the RACH resource configuration corresponding to the slice or slice group. According to an embodiment, SSB-PerRACH-OccasionAndCB-PreamblesPerSSB may always be included in the RACH resource configuration corresponding to the slice or a slice group.

According to an embodiment, an embodiment of configuring a RACH resource corresponding to a slice or a slice group may not always include a PRACH configuration index (prach-ConfigurationIndex). For example, when the RO corresponding to the corresponding RACH resource configuration is shared with another RACH resource configuration, the PRACH configuration index may not be included. Here, the RACH resource configuration may include an index of another RACH resource configuration sharing the RO. For example, if the third RACH resource configuration, the fifth RACH resource configuration, and the sixth RACH resource configuration share an RO, the PRACH configuration index may be included in the third RACH resource configuration, and the fifth RACH resource configuration and the sixth RACH resource configuration may include an index indicating the third RACH resource configuration. Alternatively, the base station may configure respective RACH resource configurations by allocating the same RACH resource configuration index to the RACH resource configurations sharing the RO.

For example, if the third RACH resource configuration, the fifth RACH resource configuration, and the sixth RACH resource configuration share the RO, the PRACH configuration index may be included in the third RACH resource configuration, and the third RACH resource configuration may include the RACH resource configuration index. The fifth RACH resource configuration and the sixth RACH resource configuration may include the same RACH resource configuration index included in the third RACH resource configuration. SSB-SharedRO-MaskIndex may optionally be included in the RACH resource configuration, and when this information is included, the SSB-SharedRO-MaskIndex may be used to indicate the subset of RO indicated by the PRACH configuration index of the RACH resource configuration corresponding to a slice or slice group, and the corresponding slice or slice group may use the indicated subset of RO. If the SSB-SharedRO-MaskIndex is not included in the RACH resource configuration, this indicates that the terminal may use all ROs indicated by the PRACH configuration index of the RACH resource configuration corresponding to a slice or slice group.

According to an embodiment, SSB-PerRACH-OccasionAndCB-PreamblesPerSSB may always be included in the RACH resource configuration corresponding to a slice or a slice group. Alternatively, according to an embodiment, SSB-PerRACH-OccasionAndCB-PreamblesPerSSB may not be included in the RACH resource configuration corresponding to a slice or slice group, but CB-PreamblesPerSSB-PerSharedRO may be included in the RACH resource configurations in which the RO is shared. Here, the SSB-PerRACH-OccasionAndCB-PreamblesPerSSB and the PRACH configuration index (prach-ConfigurationIndex) may be included in only one RACH resource configuration among RACH resource configurations sharing the RO.

According to an embodiment, the RACH resource configuration corresponding to a slice or a slice group may not always include a PRACH configuration index (prach-ConfigurationIndex). For example, when the RO corresponding to the corresponding RACH resource configuration is shared with another RACH resource configuration, the PRACH configuration index may not be included. The base station may continuously configure the RACH resource configurations sharing the RO, and the first RACH resource configuration among the RACH resource configurations sharing the RO may include a PRACH configuration index. SSB-SharedRO-MaskIndex may optionally be included in the RACH resource configuration, and when this information is included, the SSB-SharedRO-MaskIndex may be used to indicate the subset of RO indicated by the PRACH configuration index of the RACH resource configuration corresponding to a slice or slice group, and the corresponding slice or slice group may use the indicated subset of RO. If the SSB-SharedRO-MaskIndex is not included in the RACH resource configuration, this indicates that the terminal may use all ROs indicated by the PRACH configuration index of the RACH resource configuration corresponding to a slice or slice group.

According to an embodiment, SSB-PerRACH-OccasionAndCB-PreamblesPerSSB may always be included in the RACH resource configuration corresponding to a slice or a slice group. Alternatively, according to an embodiment, SSB-PerRACH-OccasionAndCB-PreamblesPerSSB may not be included in the RACH resource configuration corresponding to a slice or slice group, but CB-PreamblesPerSSB-PerSharedRO may be included in RACH resource configurations in which the RO is shared. Here, the SSB-PerRACH-OccasionAndCB-PreamblesPerSSB and the PRACH configuration index (prach-ConfigurationIndex) may be included in only one RACH resource configuration among RACH resource configurations sharing the RO.

In connection with the RACH resource configuration described above, configuration information for mapping a slice or slice group to be used for the RACH resource configuration may be transmitted from the base station to the terminal as follows.

A first scheme of configuring RACH resources for a slice or a slice group is as follows. In order to indicate an RACH resource configuration corresponding to a slice or a slice group, a base station may configure a slice list for a slice or a slice group (that is, corresponding to a list of one or multiple slice identifiers or slice group identifiers), and the base station may configure the RACH resource configuration. The RACH resource configuration may include at least one of PRACH configuration index (prach-ConfigurationIndex), SSB-PerRACH-OccasionAndCB-PreamblesPerSSB, SSB-SharedRO-MaskIndex, and CB-PreamblesPerSSB-PerSharedRO, or a combination thereof.

Here, the base station may implicitly configure the index of the slice information according to the order of the slice or slice group configured in the slice list, and the RACH resource configuration may include the index of the mapped slice information. For example, if the slice list includes {slice A, slice B, and slice C}, slice A may correspond to index 0, slice B may correspond to index 1, and slice C may correspond to index 2, and the base station may configure the RACH resource configuration corresponding to a slice/slice group by including index 0 in the RACH resource configuration to be used by index 0, including index 1 in the RACH resource configuration to be used by index 1, and including index 2 in the RACH resource configuration to be used by index 2. On the other hand, the above example is for convenience of explanation, and the disclosure is not limited thereto.

A second scheme of configuring RACH resources for a slice or a slice group is as follows. The base station may configure a RACH resource configuration list, and each RACH resource configuration may include a mapped slice identifier or slice group identifier. The RACH resource configuration may include at least one of PRACH configuration index (prach-ConfigurationIndex), SSB-PerRACH-OccasionAndCB-PreamblesPerSSB, SSB-SharedRO-MaskIndex, and CB-PreamblesPerSSB-PerSharedRO, or a combination thereof.

A third scheme of configuring RACH resources for a slice or a slice group is as follows. The base station may configure a slice list for a slice or slice group (i.e., corresponding to a list of one or multiple slice identifiers or slice group identifiers), and the base station may configure the RACH resource configuration. The RACH resource configuration may include at least one of PRACH configuration index (prach-ConfigurationIndex), SSB-PerRACH-OccasionAndCB-PreamblesPerSSB, SSB-SharedRO-MaskIndex, and CB-PreamblesPerSSB-PerSharedRO, or a combination thereof. The base station may configure an index of slice information for a slice or slice group configured in the slice list, and the RACH resource configuration may include an index of mapped slice information.

For example, if the slice list includes {slice A, slice B, and slice C}, the base station may configure a slice list including a slice and an index corresponding thereto by configuring slice A by index 0, configuring slice B by index 1, and configuring slice C by index 2. The base station may configure the RACH resource configuration information corresponding to a slice/slice group by including index 0 in the RACH resource configuration to be used by index 0, including index 1 in the RACH resource configuration to be used by index 1, and including index 2 in the RACH resource configuration to be used by index 2. On the other hand, the above example is for convenience of explanation, and the disclosure is not limited thereto.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, slice information for a cell reselection;
identifying a slice among one or more slices based on slice priority information;
identifying a cell that is a strongest and suitable cell based on the slice information; and
in case that the cell supports the slice, selecting the cell.

2. The method of claim 1, wherein identifying the slice comprises:
selecting the slice in priority order starting with a highest priority slice among the one or more slices.

3. The method of claim 1,
wherein, in case that the cell does not supports the slice, the cell is not selected.

4. The method of claim 1, wherein identifying the cell comprises:
identifying priority information for one or more frequencies associated with the slice based on the slice information;
performing a measurement for the one or more frequencies starting with a highest priority frequency based on the priority information; and
identifying the cell that is the strongest and suitable cell based on a result of the measurement.

5. The method of claim 1,
wherein the slice information for the cell reselection includes at least one of slice information for a serving cell and slice information for a neighboring cell,
wherein the slice information for the serving cell includes at least one of intra-frequency cell reselection information for the serving cell or inter-frequency cell reselection information for the serving cell,
wherein the slice information for the neighboring cell includes at least one of intra-frequency cell reselection information for the neighboring cell or inter-frequency cell reselection information for the neighboring cell, and
wherein the slice information for the cell reselection is received via at least one of a system information block (SIB) or a radio resource control (RRC) message.

6. A terminal in a communication system, the terminal comprising:
a transceiver; and
a controller coupled with the transceiver and configured to:
receive, from a base station, slice information for a cell reselection,
identify a slice among one or more slices based on slice priority information,
identify a cell that is a strongest and suitable cell based on the slice information, and
in case that the cell supports the slice, select the cell.

7. The terminal of claim 6, wherein the controller is configured to:
select the slice in priority order starting with a highest priority slice among the one or more slices.

8. The terminal of claim 6,
wherein, in case that the cell does not supports the slice, the cell is not selected.

9. The terminal of claim 6, wherein the controller is configured to:
identify priority information for one or more frequencies associated with the slice based on the slice information,
perform a measurement for the one or more frequencies starting with a highest priority frequency based on the priority information, and
identify the cell that is the strongest and suitable cell based on a result of the measurement.

10. The terminal of claim 6,
wherein the slice information for the cell reselection includes at least one of slice information for a serving cell and slice information for a neighboring cell,
wherein the slice information for the serving cell includes at least one of intra-frequency cell reselection information for the serving cell or inter-frequency cell reselection information for the serving cell,
wherein the slice information for the neighboring cell includes at least one of intra-frequency cell reselection information for the neighboring cell or inter-frequency cell reselection information for the neighboring cell, and
wherein the slice information for the cell reselection is received via at least one of a system information block (SIB) or a radio resource control (RRC) message.

11. A method performed by a base station in a communication system, the method comprising:
transmitting, to a base station, slice information for a cell reselection,
wherein a slice among one or more slices is identified based on slice priority information,
wherein a cell that is a strongest and suitable cell is identified based on the slice information, and
wherein, in case that the cell supports the slice, the cell is selected.

12. The method of claim 11,
wherein the slice is selected in priority order starting with a highest priority slice among the one or more slices.

13. The method of claim 11,
wherein, in case that the cell does not supports the slice, the cell is not selected.

14. The method of claim 11,
wherein priority information for one or more frequencies associated with the slice is identified based on the slice information,
wherein a measurement for the one or more frequencies is performed starting with a highest priority frequency based on the priority information, and
wherein the cell that is the strongest and suitable cell is identified based on a result of the measurement.

15. The method of claim 11,
wherein the slice information for the cell reselection includes at least one of slice information for a serving cell and slice information for a neighboring cell,
wherein the slice information for the serving cell includes at least one of intra-frequency cell reselection information for the serving cell or inter-frequency cell reselection information for the serving cell,
wherein the slice information for the neighboring cell includes at least one of intra-frequency cell reselection information for the neighboring cell or inter-frequency cell reselection information for the neighboring cell, and
wherein the slice information for the cell reselection is transmitted via at least one of a system information block (SIB) or a radio resource control (RRC) message.

16. A base station in a communication system, the base station comprising:
a transceiver; and
a controller coupled with the transceiver and configured to:
transmit, to a base station, slice information for a cell reselection,
wherein a slice among one or more slices is identified based on slice priority information,
wherein a cell that is a strongest and suitable cell is identified based on the slice information, and
wherein, in case that the cell supports the slice, the cell is selected.

17. The base station of claim 16,
wherein the slice is selected in priority order starting with a highest priority slice among the one or more slices.

18. The base station of claim 16,
wherein, in case that the cell does not supports the slice, the cell is not selected.

19. The base station of claim 16,
wherein priority information for one or more frequencies associated with the slice is identified based on the slice information,
wherein a measurement for the one or more frequencies is performed starting with a highest priority frequency based on the priority information, and
wherein the cell that is the strongest and suitable cell is identified based on a result of the measurement.

20. The base station of claim 16,
wherein the slice information for the cell reselection includes at least one of slice information for a serving cell and slice information for a neighboring cell,
wherein the slice information for the serving cell includes at least one of intra-frequency cell reselection information for the serving cell or inter-frequency cell reselection information for the serving cell,
wherein the slice information for the neighboring cell includes at least one of intra-frequency cell reselection information for the neighboring cell or inter-frequency cell reselection information for the neighboring cell, and
wherein the slice information for the cell reselection is transmitted via at least one of a system information block (SIB) or a radio resource control (RRC) message.
